(19) United States
(12) Patent Application Publication
(10) Pub. No.: US 2025/0270111 A1
(43) Pub. Date: Aug. 28, 2025

(54) POSITIVE ELECTRODE ACTIVE MATERIAL AND SECONDARY BATTERY

(71) Applicant: SEMICONDUCTOR ENERGY LABORATORY CO., LTD., Atsugi-shi, Kanagawa-ken (JP)

(72) Inventors: Yusuke YOSHITANI, Isehara, Kanagawa (JP); Takashi HIRAHARA, Isehara, Kanagawa (JP); Tetsuji ISHITANI, Atsugi, Kanagawa (JP); Yasuhiro JINBO, Isehara, Kanagawa (JP); Tetsuya KAKEHATA, Isehara, Kanagawa (JP); Takayuki IKEDA, Atsugi, Kanagawa (JP); Shunpei YAMAZAKI, Setagaya, Tokyo (JP)

(21) Appl. No.: 18/857,850

(22) PCT Filed: Apr. 7, 2023
(86) PCT No.: PCT/IB2023/053562

§ 371 Date: Oct. 18, 2024

(30) Foreign Application Priority Data
Apr. 21, 2022 (JP) 2022-069971

(51) Int. Cl. C01G 53/506

(52) U.S. Cl. CPC C01G 53/506; C01P 2002/01; C01P 2002/60; C01P 2002/70; C01P 2002/85; C01P 2004/03; C01P 2004/04; C01P 2006/40

(57) ABSTRACT

A positive electrode active material with excellent charge and discharge rate characteristics and a secondary battery using the positive electrode active material are provided. The positive electrode active material in which a crystallite size calculated using an XRD pattern is greater than or equal to 150 nm; the ratio of nickel to the total number of transition metal atoms is higher in an inner portion than in a first surface portion and a second surface portion; the ratio of the number of atoms of at least one element selected from cobalt and manganese to the total number of transition metal atoms is higher in the second surface portion than in the inner portion; and the concentration of at least one of additive elements is higher in the first surface portion than in the inner portion and the second surface portion is provided.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 and Non-Patent Document 1).

### REFERENCES

### Patent Document

[Patent Document 1] Japanese Published Patent Application No. 2020-068210

### Non-Patent Document

[Non-Patent Document 1] S.-W. Woo et al, “Improvement of electrochemical and thermal properties of Li[Ni_{0.8}Co_{0.1}Mn_{0.1}]O₂ positive electrode materials by multiple metal (Al, Mg) substitution”, Electrochimica Acta 54 (2009) 3851-3856

### SUMMARY OF THE INVENTION

### Problems to be Solved by the Invention

Development of lithium-ion secondary batteries is susceptible to improvement in terms of charge and discharge rate characteristics, discharge capacity, cycle performance, reliability, safety, cost, and other various aspects.

Therefore, as positive electrode active materials used for the above, materials that can improve charge and discharge rate characteristics, discharge capacity, cycle performance, reliability, safety, cost, and the like when used in secondary batteries have been needed.

An object of one embodiment of the present invention is to provide a positive electrode active material or a composite oxide which can be used for a lithium-ion secondary battery and has favorable charge and discharge rate characteristics. Another object is to provide a highly safe or highly reliable secondary battery.

Another object of one embodiment of the present invention is to provide a positive electrode active material, a composite oxide, a power storage device, or a manufacturing method thereof.

Note that the description of these objects does not preclude the existence of other objects. One embodiment of the present invention does not need to achieve all these objects. Other objects can be derived from the descriptions of the specification, the drawings, and the claims.

### Means for Solving the Problems

One embodiment of the present invention is a positive electrode active material containing a transition metal M, oxygen, and an additive element. The transition metal M is nickel, manganese, and cobalt. The additive element is one or two or more selected from magnesium, aluminum, calcium, titanium, and zirconium. The positive electrode active material includes a first surface portion, a second surface portion, and an inner portion. The second surface portion is closer to the inner portion than the first surface portion is. A ratio of nickel to the total number of transition metal M atoms is higher in the inner portion than in the first surface portion and the second surface portion. A ratio of the number of atoms of at least one element selected from cobalt and manganese to the total number of transition metal M atoms is higher in the second surface portion than in the inner portion. A concentration of at least one of the additive elements is higher in the first surface portion than in the inner portion and the second surface portion.

Another embodiment of the present invention is a secondary battery including a positive electrode including a positive electrode active material and a negative electrode. The positive electrode active material contains a transition metal M, oxygen, and an additive element. The transition metal M is nickel, manganese, and cobalt. The additive element is one or two or more selected from magnesium, aluminum, calcium, titanium, and zirconium. The positive electrode active material includes a first surface portion, a second surface portion, and an inner portion. The second surface portion is closer to the inner portion than the first surface portion is. A ratio of nickel to the total number of transition metal M atoms is higher in the inner portion than in the first surface portion and the second surface portion. A ratio of the number of atoms of at least one element selected from cobalt and manganese to the total number of transition metal M atoms is higher in the second surface portion than in the inner portion. A concentration of at least one of the additive elements is higher in the first surface portion than in the inner portion and the second surface portion.

In the above, a crystallite size of the positive electrode active material calculated using an XRD pattern is preferably greater than or equal to 150 nm.

Another embodiment of the present invention is a positive electrode active material containing a transition metal M and oxygen. The transition metal M is nickel, manganese, and cobalt. A crystallite size of the positive electrode active material calculated using an XRD pattern is greater than or equal to 150 nm. After CC/CV (4.5 V, 100 mA/g, and 10 mA/g cut) charging at 25° C., a secondary battery using the positive electrode active material has a discharge capacity of higher than or equal to 70 mAh/g in CC (constant current) at 2000 mA/g.

Another embodiment of the present invention is a secondary battery including a positive electrode including a positive electrode active material and a negative electrode. The positive electrode active material contains a transition metal M and oxygen. The transition metal M is nickel, manganese, and cobalt. A crystallite size of the positive electrode active material calculated using an XRD pattern is greater than or equal to 150 nm. After CC/CV (4.5 V, 100 mA/g, and 10 mA/g cut) charging at 25° C., the secondary battery has a discharge capacity of higher than or equal to 70 mAh/g in CC (constant current) at 2000 mA/g.

### Effect of the Invention

One embodiment of the present invention can provide a positive electrode active material or a composite oxide which can be used for a lithium-ion secondary battery and has favorable charge and discharge rate characteristics. Alternatively, a highly safe or highly reliable secondary battery can be provided.

Another embodiment of the present invention can provide a positive electrode active material, a composite oxide, a power storage device, or a manufacturing method thereof.

Note that the description of these effects does not preclude the existence of other effects. One embodiment of the present invention does not need to have all these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1A to FIG. 1C are cross-sectional views of a positive electrode active material.

FIG. 2 is an example of a TEM image showing crystal orientations substantially aligned with each other.

FIG. 3A is an example of a STEM image showing crystal orientations substantially aligned with each other. FIG. 3B shows an FFT pattern of a region of a rock-salt crystal RS. FIG. 3C shows an FFT pattern of a region of a layered rock-salt crystal LRS.

FIG. 4A and FIG. 4B are cross-sectional views of a positive electrode active material.

FIG. 5A to FIG. 5C are cross-sectional views of a positive electrode active material.

FIG. 6 is a diagram showing a method for forming a positive electrode active material.

FIG. 7 is a diagram showing a method for forming a positive electrode active material.

FIG. 8 is a diagram showing a method for forming a positive electrode active material.

FIG. 9 is a diagram showing a method for forming a positive electrode active material.

FIG. 10A to FIG. 10D are cross-sectional views showing examples of a positive electrode of a secondary battery.

FIG. 11A is an exploded perspective view of a coin-type secondary battery, FIG. 11B is a perspective view of the coin-type secondary battery, and FIG. 11C is a cross-sectional perspective view thereof.

FIG. 12A shows an example of a cylindrical secondary battery. FIG. 12B shows the example of the cylindrical secondary battery. FIG. 12C shows an example of a plurality of cylindrical secondary batteries. FIG. 12D shows an example of a power storage system including a plurality of cylindrical secondary batteries.

FIG. 13A and FIG. 13B are diagrams showing examples of a secondary battery, and FIG. 13C is a diagram illustrating an internal state of the secondary battery.

FIG. 14A to FIG. 14C are diagrams showing an example of a secondary battery.

FIG. 15A and FIG. 15B are diagrams illustrating external views of secondary batteries.

FIG. 16A to FIG. 16C are diagrams illustrating a method for manufacturing a secondary battery.

FIG. 17A is a perspective view of a battery pack of one embodiment of the present invention, FIG. 17B is a block diagram of the battery pack, and FIG. 17C is a block diagram of a vehicle including the battery pack.

FIG. 18A to FIG. 18D are diagrams showing examples of transport vehicles. FIG. 18E is a diagram showing an example of an artificial satellite.

FIG. 19A is a diagram illustrating an electric bicycle, FIG. 19B is a diagram illustrating a secondary battery of the electric bicycle, and FIG. 19C is a diagram illustrating a scooter.

FIG. 20A to FIG. 20D are diagrams showing examples electronic devices.

FIG. 21A to FIG. 21F are surface SEM images of positive electrode active materials.

FIG. 22A and FIG. 22B are graphs showing discharge rate characteristics of secondary batteries.

FIG. 23A and FIG. 23B are graphs showing charge rate characteristics of secondary batteries.

FIG. 24A to FIG. 24H are surface SEM images of positive electrode active materials.

FIG. 25A to FIG. 25C are cross-sectional SEM images of positive electrode active materials, and

FIG. 25D to FIG. 25F are graphs showing results of EDX point analysis.

### MODE FOR CARRYING OUT THE INVENTION

Examples of embodiments of the present invention will be described below with reference to the drawings and the like. Note that the present invention should not be interpreted as being limited to the examples of embodiments given below. Embodiments of the invention can be changed unless it deviates from the spirit of the present invention.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

Uniformity refers to a state where, in a solid made of a plurality of elements (e.g., A, B, and C), a certain element (e.g., A) is distributed with similar features in specific regions. Note that it is acceptable for the specific regions to have substantially the same concentration of the element. For example, a difference in the detected amount of the certain element (e.g., the count number obtained by STEM-EDX) between the specific regions is 10% or less. Examples of the specific regions include a surface portion, a surface, a projected portion, a depressed portion, and an inner portion.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in this specification and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The potential of a positive electrode generally increases with increasing charge voltage of a secondary battery. The positive electrode active material of one embodiment of the present invention has a stable crystal structure even at a high charge voltage. The stable crystal structure of the positive electrode active material in a charged state can inhibit a charge and discharge capacity decrease due to repeated charging and discharging.

A short circuit of a secondary battery might cause not only a malfunction in charging operation and/or discharging operation of the secondary battery but also heat generation and ignition. In order to obtain a safe secondary battery, a short-circuit current is preferably inhibited even at a high charge voltage. In the positive electrode active material of one embodiment of the present invention, a short-circuit current is inhibited even at a high charge voltage. Thus, a secondary battery having a high discharge capacity and a high level of safety can be obtained.

The description is made on the assumption that materials (such as a positive electrode active material, a negative electrode active material, an electrolyte, and a separator) of a secondary battery have not deteriorated unless otherwise specified. A decrease in discharge capacity due to aging treatment (also referred to as burn-in treatment) during the manufacturing process of a secondary battery is not regarded as deterioration. For example, the case where discharge capacity is higher than or equal to 97% of the rated capacity of a lithium-ion secondary battery cell and an assembled lithium secondary battery (hereinafter, referred to as a lithium-ion secondary battery) can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

### Embodiment 1

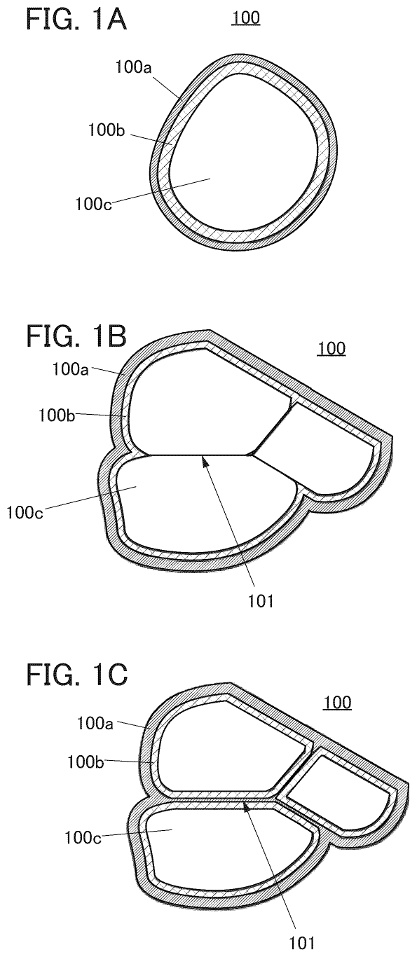

In this embodiment, a positive electrode active material 100 of one embodiment of the present invention is described with reference to FIG. 1 to FIG. 5.

### <Contained Element>

The positive electrode active material 100 contains lithium, a transition metal M, and oxygen. The transition metal M is one or two or more selected from nickel, manganese, and cobalt. In addition to those, an additive element is preferably contained. Alternatively, the positive electrode active material 100 can contain lithium nickel-manganese-cobalt oxide to which an additive element is added.

A positive electrode active material of a lithium-ion secondary battery needs to contain a transition metal which can take part in an oxidation-reduction reaction in order to maintain a neutrally charged state even when lithium ions are inserted and extracted. The positive electrode active material 100 of one embodiment of the present invention contains nickel, manganese, and cobalt as the transition metals M which take part in an oxidation-reduction reaction.

Nickel preferably accounts for a large percentage of the transition metal M contained in the positive electrode active material 100 because it is easier to increase the charge and discharge capacity than in the case where cobalt accounts for more than half, even when charge voltage is low. Thus, nickel preferably accounts for 50% or more of the transition metal M, further preferably 60% or more, still further preferably 75% or more, for example.

As the additive element contained in the positive electrode active material 100, one or two or more selected from magnesium, aluminum, calcium, titanium, zirconium, fluorine, vanadium, iron, manganese, chromium, niobium, arsenic, zinc, silicon, sulfur, phosphorus, boron, bromine, and beryllium are preferably used. The ratio of the number of atoms of the additive element to the total number of atoms of the transition metal M is preferably lower than 25 atomic %, further preferably lower than 10 atomic %, still further preferably lower than 5 atomic %.

As described later, such an additive element further stabilizes a crystal structure of the positive electrode active material 100. In this specification and the like, the additive element can be rephrased as a mixture or part of a raw material.

Note that as the additive element, magnesium, aluminum, calcium, titanium, zirconium, fluorine, vanadium, iron, manganese, chromium, niobium, arsenic, zinc, silicon, sulfur, phosphorus, boron, bromine, or beryllium is not necessarily contained.

### <Single Particle>

A particle of the positive electrode active material 100 is preferably a single crystal. In the case where the positive electrode active material 100 is a single crystal particle, the single crystal particle is referred to as a single particle in some cases. The crystallite size of the positive electrode active material 100 is preferably large.

When primary particles are large, formation of secondary particles by aggregation and sintering of the primary particles is inhibited. A large primary particle leads to a large crystallite size calculated using the half width of the XRD diffraction pattern, as a foregone conclusion. Accordingly, the positive electrode active material 100 which is a single particle or which has a large crystallite size calculated using the XRD diffraction pattern has no crack or fewer cracks that might be generated between primary particles as compared to a positive electrode active material formed by sintering of a large number of primary particles. Thus, cracks can be expected to be inhibited even when the volume of the positive electrode active material 100 is changed by charging and discharging.

The crystallite size calculated from the half width of the XRD diffraction pattern is preferably greater than or equal to 150 nm, further preferably greater than or equal to 180 nm, still further preferably greater than or equal to 200 nm, for example.

Note that long-time or high-temperature heating or heating after addition of lithium in excess of that in the stoichiometric composition is necessary to obtain a large single crystal or a large crystallite size in some cases. However, a long-time heating step reduces the productivity. Heating at high temperatures might cause cation mixing between nickel ions and lithium ions. Furthermore, excess lithium might cause gelling of a binder when slurry for a positive electrode is formed. The single crystal size and the crystallite size are preferably set as appropriate while avoiding the above problems.

For example, the crystallite size calculated from the XRD diffraction pattern is preferably less than or equal to 1000 nm, further preferably less than or equal to 800 nm. A positive electrode active material whose crystallite size calculated from the XRD diffraction pattern is within the above range can be regarded as a positive electrode active material having a sufficiently large crystallite size and having features close to those of a single particle.

An XRD pattern for calculation of the half width may be obtained in a state of the positive electrode active material alone, or may be obtained in a state of a positive electrode including a current collector, a binder, a conductive material, and the like in addition to the positive electrode active material. Note that the positive electrode active material may have orientation in the positive electrode owing to, for example, pressure application in a formation process. When the positive electrode active material has high orientation, the crystallite size might fail to be calculated accurately. Thus, it is preferable to obtain an XRD pattern in the following manner that lowers orientation: a positive electrode active material layer is separated from the positive electrode, the binder and the like in the positive electrode active material layer are removed to some extent using a solvent or the like, and a sample holder is filled with the resultant positive electrode active material, for example.

### <<XRD>>

The apparatus and conditions for the XRD measurement in calculating the crystallite size are not particularly limited. The measurement can be performed with the apparatus and conditions as described below, for example.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

By analyzing the obtained XRD diffraction pattern using crystal structure analysis software (e.g., TOPAS ver. 3), the crystallite size can be calculated.

### <Surface Portion>

FIG. 1A is a cross-sectional view in the case where the positive electrode active material 100 is a single particle. The positive electrode active material 100 preferably includes a surface portion and an inner portion 100c. The surface portion preferably includes a surface portion 100a and a surface portion 100b. The surface portion 100b is closer to the inner portion 100c than the surface portion 100a is.

In this specification and the like, the surface portion 100a of the positive electrode active material 100 refers to a region from the surface to a depth of less than or equal to 200 nm toward the inner portion, for example. The surface portion 100b of the positive electrode active material 100 refers to a region from the surface to a depth of greater than 200 nm and less than or equal to 1000 nm toward the inner portion, for example. A plane generated by a split and/or a crack can also be referred to as a surface. The surface portion can be rephrased as the vicinity of a surface, a region in the vicinity of a surface, or a shell.

The inner portion 100c refers to a region deeper than the surface portion of the positive electrode active material. The inner portion 100c can be rephrased as an inner region or a core.

A surface of the positive electrode active material 100 refers to a surface of a composite oxide including the surface portion and the inner portion 100c. Thus, the positive electrode active material 100 does not include a carbonate, a hydroxy group, or the like which is chemically adsorbed after formation of the positive electrode active material 100. Furthermore, an electrolyte, a binder, a conductive material, and a compound originating from any of these that are attached to the positive electrode active material 100 are not included either. The surface of the positive electrode active material 100 in, for example, a cross-sectional STEM (scanning transmission electron microscope) image is a boundary between a region where a bonding image of an electron beam is observed and a region where the image is not observed, and is determined as the outermost surface of a region where a bright spot derived from an atomic nucleus of a metal element that has a larger atomic number than lithium is observed. The surface in across-sectional STEM image or the like may be determined also on the basis of higher spatial-resolution analysis results, e.g., electron energy loss spectroscopy (EELS) analysis results.

Each of FIG. 1B and FIG. 1C is a cross-sectional view of the positive electrode active material 100 that is a secondary particle including a primary particle with a large crystallite size, and includes a crystal grain boundary 101. The surface portion 100a and the surface portion 100b do not necessarily exist around the crystal grain boundary 101, as illustrated in FIG. 1B or may exist as illustrated in FIG. 1C.

The crystal grain boundary 101 refers to, for example, a portion where primary particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in cross-sectional TEM (transmission electron microscope), a cross-sectional STEM image, or the like, i.e., a structure containing another element between lattices, a cavity, or the like. The crystal grain boundary 101 can be regarded as one of plane defects. The vicinity of the crystal grain boundary 101 refers to a region within 10 nm from the crystal grain boundary 101.

The crystal grain boundary is one of plane defects, and thus tends to be unstable and suffer a change in the crystal structure like the surface of the particle. Thus, the higher the concentration of the additive element in the crystal grain boundary and its vicinity is, the more effectively the change in the crystal structure can be inhibited as described later.

When the concentration of the additive element is high at the crystal grain boundary 101 and the vicinity thereof, the concentration of the additive element in the vicinity of a surface generated by a crack is high even when the crack is generated along the crystal grain boundary of the positive electrode active material 100 of one embodiment of the present invention. Thus, also the surface portion generated by a crack can have a more stable crystal structure.

### <Crystal Structure>

The positive electrode active material 100 of one embodiment of the present invention preferably has a layered rock-salt crystal structure belonging to the space group R-3m in a discharged state, i.e., a state where x in LiₓMO₂ (M is at least one of Ni, Co, and Mn) is 1. A composite oxide having a layered rock-salt structure excels as a positive electrode active material of a secondary battery because it has high discharge capacity and a two-dimensional diffusion path for lithium ions and is thus suitable for an insertion and extraction reaction of lithium ions. For this reason, it is particularly preferable that the inner portion 100c, which accounts for the majority of the volume of the positive electrode active material 100, have a layered rock-salt crystal structure.

Meanwhile, the surface portion of the positive electrode active material 100 of one embodiment of the present invention preferably has a function of reinforcing the layered structure, which is formed of octahedrons of the transition metal M and oxygen, of the inner portion 100c so that the layered structure does not break even when a large amount of lithium is extracted from the positive electrode active material 100 by charging. Alternatively, the surface portion preferably functions as a barrier film of the positive electrode active material 100. Alternatively, the surface portion, which is the outer portion of the positive electrode active material 100, preferably reinforces the positive electrode active material 100. Here, the term “reinforce” means inhibition of a change in the structures of the surface portion and the inner portion 100c of the positive electrode active material 100 such as extraction of oxygen and/or inhibition of oxidative decomposition of an electrolyte on the surface of the positive electrode active material 100. That is, “functions as a barrier film” means that, for example, the surface portion inhibits a change in the structure of the positive electrode active material 100 and inhibits oxidative decomposition of an electrolyte.

Accordingly, the surface portion preferably has a composition and a crystal structure different from those of the inner portion 100c. The surface portion preferably has a more stable composition and a more stable crystal structure than those of the inner portion 100c at room temperature (25° C.). For example, at least part of the surface portion of the positive electrode active material 100 of one embodiment of the present invention preferably has a rock-salt crystal structure. Alternatively, the surface portion preferably has both a layered rock-salt crystal structure and a rock-salt crystal structure. Alternatively, the surface portion preferably has features of both a layered rock-salt crystal structure and a rock-salt crystal structure.

The surface portion is a region from which lithium ions are extracted initially in charging, and is a region that tends to have a lower concentration of lithium than the inner portion 100c. Bonds between atoms are regarded as being partly cut on the surface of the positive electrode active material 100 included in the surface portion. Thus, the surface portion is regarded as a region that tends to be unstable and easily starts deterioration of the crystal structure. Meanwhile, when the surface portion can be made sufficiently stable, the layered structure, which is formed of octahedrons of the transition metal M and oxygen, of the inner portion 100c is unlikely to be broken even with small x in LiₓMO₂. Furthermore, a shift in layers, which are formed of octahedrons of the transition metal M and oxygen, of the inner portion 100c can be inhibited.

In order that the surface portion can have a stable composition and a stable crystal structure, the surface portion preferably contains an additive element, further preferably contains a plurality of additive elements. Furthermore, the composition of the transition metal M is preferably different between the surface portion and the inner portion 100c.

For example, the concentration peak of the additive element is preferably located in the surface portion, and the concentration peak of the additive element is further preferably located in the surface portion 100a closer to the surface.

The concentration of at least one of cobalt and manganese among the transition metals M is preferably higher in the surface portion than in the inner portion 100c. Similarly, the concentration of nickel is preferably higher in the inner portion 100c than in the surface portion. The concentration of at least one of cobalt and manganese preferably has a gradient that increases toward the surface of the positive electrode active material 100. Similarly, the concentration of nickel preferably has a gradient that increases toward the inner portion of the positive electrode active material 100.

In view of the above, the surface portion 100b is preferably a region having no concentration peak of the additive element but having higher concentrations of cobalt and manganese than the inner portion 100c.

The surface portion 100a preferably has a higher concentration of one or two or more selected from the additive elements than the surface portion 100b and the inner portion 100c. The one or two or more selected from the additive elements contained in the positive electrode active material 100 preferably have a concentration gradient. It is further preferable that the additive elements contained in the positive electrode active material 100 be differently distributed. For example, it is further preferable that the additive elements exhibit concentration peaks at different depths from the surface. The concentration peak here refers to the local maximum value of the concentration in the surface portion 100a or the concentration in a region from the surface to a depth of 200 nm or less.

For example, some of the additive elements such as magnesium, fluorine, nickel, titanium, silicon, phosphorus, boron, and calcium preferably have a concentration gradient in which the concentration increases from the inner portion 100c toward the surface.

As described later, such an additive element further stabilizes a crystal structure of the positive electrode active material 100. Note that in addition to the additive element contained in the additive element source, a slight amount of additive element may be contained in the transition metal M source or the like. The additive element derived from any of the materials can contribute to the chemical stability of the positive electrode active material 100 as long as the concentration and distribution are preferable.

An appropriate concentration of magnesium, which is an example of the additive element, in the lithium sites of the surface portion can facilitate maintenance of the layered rock-salt crystal structure of the inner portion 100c, for example. This is probably because magnesium in the lithium sites serves as a column supporting the MO₂ layers.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Aluminum can exist in the transition metal M site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a transition metal M-O bond and thus extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is unlikely to be broken by repeated charging and discharging.

Meanwhile, excess aluminum might adversely affect insertion and extraction of lithium. Thus, the entire positive electrode active material 100 preferably contains an appropriate amount of aluminum.

An oxide of titanium, which is an example of the additive element, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains phosphorus, which is an example of the additive element, a short circuit can be inhibited while a state with small x in LiₓMO₂ is maintained, in some cases, which is preferable. For example, a compound containing phosphorus and oxygen preferably exists in the surface portion 100a. Examples of the compound containing phosphorus and oxygen include lithium phosphate.

The positive electrode active material 100 preferably contains phosphorus, in which case the phosphorus reacts with hydrogen fluoride generated by the decomposition of the electrolyte, which can decrease the hydrogen fluoride concentration in the electrolyte.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in the hydrogen fluoride concentration in the electrolyte can inhibit corrosion of a current collector and/or separation of a coating film 104 described later, in some cases. Furthermore, a reduction in adhesion properties due to gelling and/or insolubilization of PVDF can be inhibited in some cases.

The positive electrode active material 100 preferably contains magnesium and phosphorus, in which case the stability in a state with small x in LiₓMO₂ is extremely high.

In the case where the positive electrode active material 100 has a crack, crack development can be inhibited by phosphorus, more specifically, a compound containing phosphorus and oxygen, for example, being in the inner portion of the positive electrode active material having the crack on its surface, e.g., a filling portion.

Note that the surface portion occupied by only a compound of an additive element and oxygen is not preferred because this surface portion would make insertion and extraction of lithium difficult. For example, it is not preferable that the surface portion be occupied by only magnesium oxide and a structure in which magnesium oxide and an oxide of a divalent transition metal M form a solid solution. Thus, the surface portion 100a should contain at least the transition metal M, also contain lithium in a discharged state, and have the path through which lithium is inserted and extracted.

To ensure a sufficient path through which lithium is inserted and extracted, the total number of atoms of the transition metal M is preferably larger than the total number of atoms of the additive element in the surface portion 100a.

It is preferable that some additive elements, in particular, magnesium and aluminum have higher concentrations in the surface portion than in the inner portion 100c and exist randomly also in the inner portion 100c to have low concentrations. When magnesium and aluminum exist in the lithium sites of the inner portion 100c at appropriate concentrations, an effect of facilitating maintenance of the layered rock-salt crystal structure can be obtained in a manner similar to the above.

It is preferable that the crystal structure continuously change from the inner portion 100c toward the surface owing to the above-described concentration gradient of the additive element. Alternatively, it is preferable that the surface portion and the inner portion 100c have substantially the same crystal orientation.

For example, a crystal structure preferably changes continuously from the layered rock-salt inner portion 100c toward the surface and the surface portion that have a rock-salt structure or have features of both a rock-salt structure and a layered rock-salt structure. Alternatively, the crystal orientations of the surface portion with a rock-salt structure or features of both a rock-salt structure and a layered rock-salt structure are preferably substantially aligned with that of the layered rock-salt inner portion 100c.

In this specification and the like, a layered rock-salt crystal structure, which belongs to the space group R-3m, of a composite oxide containing lithium and the transition metal M refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be determined by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal. A stacked-layer structure in which two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiMO₂ are compared to each other, the distance between the bright spots on the (003) plane of LiMO₂ is observed at a distance approximately half the distance between the bright spots on the (111) plane of MgO. Thus, for instance, when two phases of rock-salt MgO and layered rock-salt LiMO₂ are included in a region to be analyzed, a plane orientation in which bright spots with high luminance and bright spots with low luminance are alternately arranged is seen in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane at which orientations of cubic closest packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that the space group of the layered rock-salt crystal is R-3m, which is different from the space group Fm-3m (the space group of a general rock-salt crystal) of the rock-salt crystal; thus, the Miller index of the crystal plane satisfying the above conditions in the layered rock-salt crystal is different from that in the rock-salt crystal. In this specification, a state where the orientations of the cubic close-packed structures composed of anions in the layered rock-salt crystal and the rock-salt crystal are aligned with each other is referred to as a state where crystal orientations are substantially aligned with each other in some cases. In addition, topotaxy refers to having similarity in a three-dimensional structure such that crystal orientations are substantially aligned with each other, or to having the same orientations crystallographically.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, and an FFT pattern of a TEM image, a STEM image, and the like. XRD (X-ray Diffraction), electron diffraction, neutron diffraction, and the like can also be used for judging.

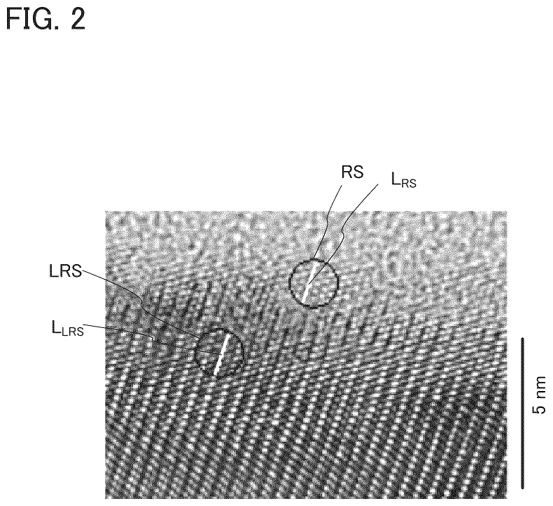

FIG. 2 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 2) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast proportional to the atomic number is obtained, and an element having a larger atomic number is observed to be brighter. For example, in the case of lithium nickel-manganese-cobalt oxide that has a layered rock-salt structure belonging to the space group R-3m, due to the large atomic numbers of the transition metals M, specifically, manganese (atomic number: 25), cobalt (atomic number: 27), and nickel (atomic number: 28), an electron beam is strongly scattered at the positions of those atoms, and arrangement of the transition metal M atoms is observed as a bright line or arrangement of high-luminance dots. Thus, when the lithium nickel-manganese-cobalt oxide having a layered rock-salt crystal structure is observed in the direction perpendicular to the c-axis of the layered rock-salt crystal structure belonging to the space group R-3m, arrangement of the transition metal M atoms is observed as a bright line or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are contained as the additive elements of the lithium nickel-manganese-cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

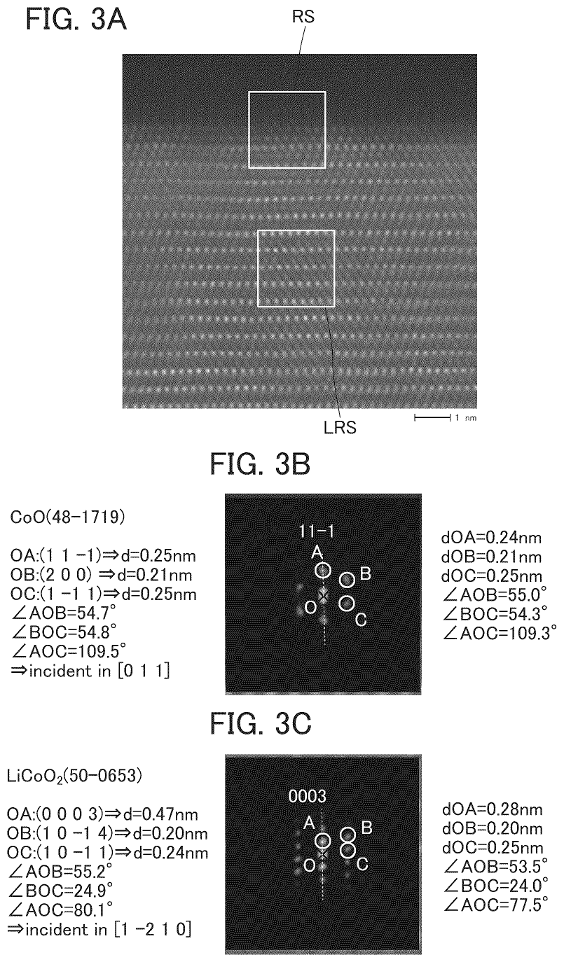

FIG. 3A shows an example of a STEM image in which orientations of the layered rock-salt crystal LRS and the rock-salt crystal RS are substantially aligned with each other. FIG. 3B shows an FFT pattern of a region of the rock-salt crystal RS, and FIG. 3C shows an FFT pattern of a region of the layered rock-salt crystal LRS. In FIG. 3B and FIG. 3C, the composition, the JCPDS card number, and d values and angles to be calculated are shown on the left. The measured values are shown on the right. A spot denoted by O is zero-order diffraction. Although an example of lithium cobalt oxide and cobalt oxide is described here, one embodiment of the present invention is not limited thereto. For example, orientations of lithium nickel-manganese-cobalt oxide and nickel oxide, manganese oxide, and/or cobalt oxide are presumed to be substantially aligned with each other in a manner similar to the above.

A spot denoted by A in FIG. 3B is derived from 11-1 reflection of a cubic structure. A spot denoted by A in FIG. 3C is derived from 0003 reflection of a layered rock-salt structure. It is found from FIG. 3B and FIG. 3C that the direction of the 11-1 reflection of the cubic structure and the direction of the 0003 reflection of the layered rock-salt structure are substantially aligned with each other. That is, a straight line that passes through AO in FIG. 3B is substantially parallel to a straight line that passes through AO in FIG. 3C. Here, the terms “substantially aligned” and “substantially parallel” mean that the angle is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 3C is derived from 1014 reflection of the layered rock-salt structure. This is sometimes observed at a position where the difference in orientation from the reciprocal lattice point derived from the 0003 reflection of the layered rock-salt crystal structure (A in FIG. 3C) is greater than or equal to 52° and less than or equal to 56° (i.e., ∠AOB is greater than or equal to 52° and less than or equal to 56°) and d is greater than or equal to 0.19 nm and less than or equal to 0.21 nm. Note that these indices are just an example, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 3B is derived from 200 reflection of the cubic structure. This diffraction spot is sometimes observed at a position where the difference in orientation of reflection derived from the 11-1 reflection of the cubic structure (A in FIG. 3B) is greater than or equal to 54° and less than or equal to 56° (i.e., ∠AOB is greater than or equal to 54° and less than or equal to 56°). Note that these indices are just an example, and the spot does not necessarily correspond with them. For example, the spot may be a reciprocal lattice point equivalent to the indices.

Note that to judge whether crystal orientations are aligned, a sample is preferably processed to be thin so that the (0003) plane of the layered rock-salt structure is easily observed. Thus, for example, a sample to be observed is preferably processed to be thin using an FIB or the like such that an electron beam of a TEM, for example, enters in [12-10]. It is known that in a layered rock-salt positive electrode active material that is LiMO₂ (M is at least one of Ni, Co, and Mn), the (0003) plane and a plane equivalent thereto and the (10-14) plane and a plane equivalent thereto are likely to be crystal planes. Thus, through careful observation of the shape of the positive electrode active material with a SEM or the like, a sample to be observed can be processed to be thin so that the (0003) plane is easily observed in a TEM or the like.

### <<XPS>>

In an inorganic oxide, a region that is approximately 2 nm to 8 nm (normally, 5 nm or less) in depth from the surface can be analyzed by X-ray photoelectron spectroscopy (XPS) using monochromated aluminum Kα radiation as an X-ray source; thus, the concentrations of elements can be quantitatively analyzed in approximately half the depth of the surface portion 100a. The bonding states of the elements can be analyzed by narrow scanning. Note that the quantitative accuracy of XPS is approximately ±1 atomic % in many cases. The lower detection limit is approximately 1 atomic % but depends on the element.

In the positive electrode active material 100 of one embodiment of the present invention, the concentration of one or two or more selected from the additive elements is preferably higher in the surface portion than in the inner portion 100c. This means that the concentration of one or two or more selected from the additive elements in the surface portion is preferably higher than the average concentration in the entire positive electrode active material 100. For this reason, for example, it is preferable that the concentration of one or two or more additive elements selected from the surface portion, which is measured by XPS or the like, be higher than the average concentration of the additive elements in the entire positive electrode active material 100, which is measured by ICP-MS (an inductively coupled plasma-mass spectrometry), GD-MS (a glow discharge mass spectrometry), or the like. For example, the concentration of magnesium in at least part of the surface portion 100a, which is measured by XPS or the like, is preferably higher than the concentration of magnesium in the entire positive electrode active material 100. The concentration of aluminum in at least part of the surface portion 100a is preferably higher than the concentration of aluminum in the entire positive electrode active material 100.

Note that the surface and the surface portion of the positive electrode active material 100 of one embodiment of the present invention do not include a carbonate, a hydroxy group, or the like which is chemically adsorbed after formation of the positive electrode active material 100, as described above. Furthermore, an electrolyte solution, a binder, a conductive material, and a compound originating from any of these that are attached to the surface of the positive electrode active material 100 are not included either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material and a positive electrode active material layer or the like may be washed, for example, to eliminate an electrolyte solution, a binder, a conductive material, or a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

In the XPS analysis, monochromatic aluminum Kα radiation can be used as an X-ray source, for example. An extraction angle is, for example, 45°. For example, the measurement can be performed using the following apparatus and conditions.
Measurement apparatus: Quantera II produced by PHI, Inc.
X-ray source: monochromatic Al Kα (1486.6 eV)
Detection area: 100 μmϕ
Detection depth: approximately 4 to 5 nm (extraction angle 45°)
Measurement spectrum: wide scanning, narrow scanning of each detected element

### <<EDX>>

The one or two or more selected from the additive elements and the transition metal M contained in the positive electrode active material 100 preferably have a concentration gradient. It is further preferable that the additive elements contained in the positive electrode active material 100 exhibit concentration peaks at different depths from the surface. The concentration gradients of the additive element and the transition metal M can be evaluated, for example, by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement for two-dimensional evaluation of an area by area scan is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive elements and the transition metals M in the surface portion, the inner portion 100c, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Thus, EDX area analysis or EDX point analysis of the positive electrode active material 100 of one embodiment of the present invention preferably reveals that the concentration of each additive element in the surface portion is higher than that in the inner portion 100c. In addition, the concentration of at least one selected from cobalt and manganese among the transition metals M is preferably higher in the surface portion than in the inner portion 100c. Similarly, the concentration of nickel is preferably higher in the inner portion 100c than in the surface portion.

For example, EDX area analysis or EDX point analysis of the positive electrode active material 100 containing magnesium and/or aluminum as the additive element preferably reveals that the concentration of magnesium and/or aluminum in the surface portion is higher than the concentration of magnesium and/or aluminum in the inner portion 100c.

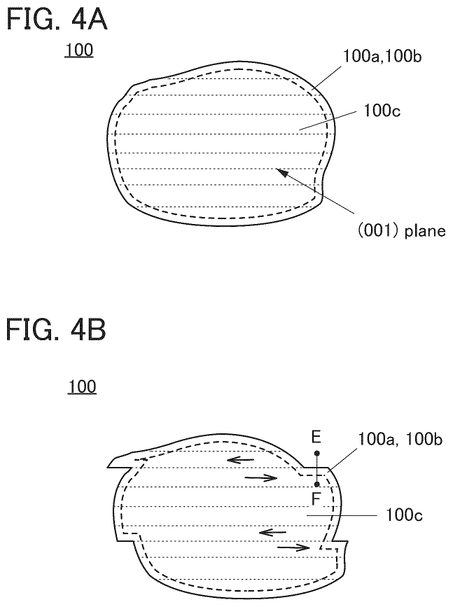

The positive electrode active material 100 preferably has a smooth surface with little unevenness; however, it is not necessary that the whole positive electrode active material 100 be in such a state. In a composite oxide having a layered rock-salt crystal structure belonging to R-3m, slipping easily occurs at a plane parallel to the (001) plane, e.g., a plane where lithium atoms are arranged. In the case where a (001) plane exists as illustrated in FIG. 4A, for example, steps such as pressing sometimes cause slipping in a direction parallel to the (001) plane as denoted by arrows in FIG. 4B, resulting in deformation.

In that case, at a surface newly formed as a result of slipping and the surface portion 100a thereof, the additive element is not present or present at a concentration lower than or equal to the lower detection limit in some cases. The line E-F in FIG. 4B denotes examples of the surface newly formed as a result of slipping and the surface portion 100a and the surface portion 100b thereof.

However, because slipping easily occurs parallel to the (001) plane, the newly formed surface and the surface portion 100a thereof easily have a (001) orientation. In this case, since a diffusion path for lithium ions is not exposed and is relatively stable, substantially no problem is caused even when the additive element is not present or concentration of the additive element is lower than or equal to the lower detection limit.

Note that as described above, in a composite oxide whose composition is LiMO₂ and which has a layered rock-salt crystal structure belonging to R-3m, the transition metals M are arranged parallel to the (001) plane. In a HAADF-STEM image, the luminance of cobalt, which has the largest atom number in LiMO₂, is the highest. Thus, in a HAADF-STEM image, arrangement of atoms with a high luminance can be regarded as arrangement of the transition metals M. Repetition of such arrangement with a high luminance can be rephrased as crystal fringes or lattice fringes.

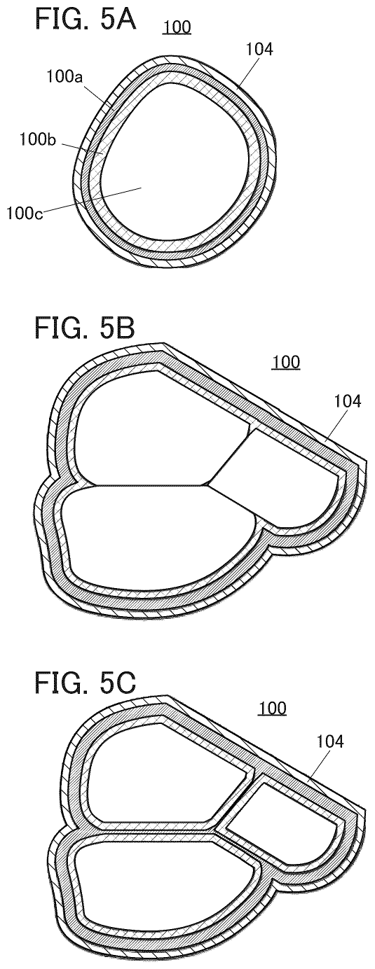

The positive electrode active material 100 may include a coating film on at least part of its surface. FIG. 5A, FIG. 5B, and FIG. 5C show examples of the positive electrode active material 100 including the coating film 104.

The coating film 104 is preferably formed by deposition of a decomposition product of an electrolyte solution due to charging and discharging, for example. A coating film originating from an electrolyte solution, which is formed on the surface of the positive electrode active material 100, is expected to improve charge and discharge cycle performance. This is because an increase in impedance of the surface of the positive electrode active material is inhibited or dissolution of the transition metal M is inhibited, for example. The coating film 104 preferably contains carbon, oxygen, and fluorine, for example. The coating film can have high quality easily when part of the electrolyte solution contains LiBOB and/or SUN (suberonitrile), for example. Accordingly, the coating film 104 containing one or two or more selected from boron, nitrogen, sulfur, and fluorine is preferable because of having high quality in some cases. The coating film 104 does not necessarily cover the positive electrode active material 100 entirely.

This embodiment can be used in appropriate combination with any of the other embodiments.

### Embodiment 2

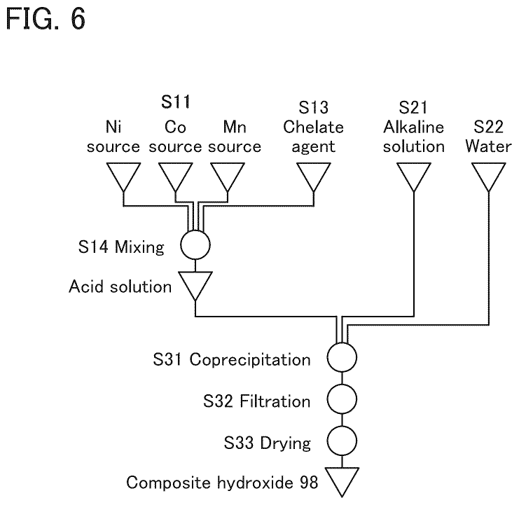

In this embodiment, examples of a method for forming the positive electrode active material 100 of one embodiment of the present invention is described with reference to FIG. 6 to FIG. 9.

A way of adding the additive element is important in forming the positive electrode active material 100 having the distribution of the additive element, the composition, and/or the crystal structure described in the above embodiment.

Thus, in the formation process of the positive electrode active material 100, preferably, lithium nickel-manganese-cobalt oxide with a large crystallite size is synthesized first, then an additive element source is mixed, and heat treatment is performed.

In order to synthesize lithium nickel-manganese-cobalt oxide with a large crystallite size, it is effective to perform a process of lithium source addition and heating a plurality of times.

In a synthesis method in which an additive element source is mixed concurrently with a nickel source, a manganese source, and a cobalt source or with a lithium source, it is difficult to increase the concentration of the additive element in the surface portion. In addition, after lithium nickel-manganese-cobalt oxide is synthesized, only mixing an additive element source without performing heating causes the additive element to be just attached to, not solid-soluted in, the lithium nickel-manganese-cobalt oxide. It is difficult to distribute the additive element favorably without sufficient heating. Therefore, it is preferable that lithium nickel-manganese-cobalt oxide be synthesized, and then an additive element source be mixed and heat treatment be performed. The heat treatment after mixing of the additive element source may be referred to as annealing.

### <<Formation Method 1 of Positive Electrode Active Material>>

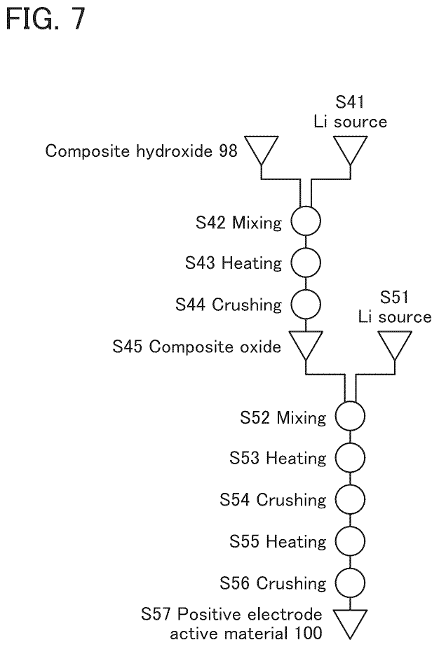

Formation method 1 of the positive electrode active material 100 will be described with reference to FIG. 6 and FIG. 7.

### <Step S11>

In Step S11 in FIG. 6, first, a transition metal M source, i.e., a nickel source (Ni source), a cobalt source (Co source), and a manganese source (Mn source) are prepared. The mixed ratio of nickel, cobalt, and manganese is preferably within a range with which a layered rock-salt crystal structure can be obtained.

It is particularly preferable that the transition metal M contained in the positive electrode active material 100 contain a large amount of nickel, in which case the cost of the raw material may be lower than that in the case of containing a large amount of cobalt and charge and discharge capacity per weight may be increased. For example, the proportion of nickel used as the transition metal M is preferably higher than 50 atomic %, further preferably higher than or equal to 60 atomic %, still further preferably higher than or equal to 75 atomic %. However, a too high proportion of nickel might decrease the chemical stability and heat resistance. Thus, the proportion of nickel used as the transition metal M is preferably lower than or equal to 95 atomic %.

Cobalt is preferably contained as the transition metal M, in which case the average discharge voltage is high and a secondary battery can be highly reliable because cobalt contributes to stabilization of a layered rock-salt structure. Meanwhile, the price of cobalt is higher and more unstable than those of nickel and manganese; thus, a too high proportion of cobalt might increase the cost for manufacturing the secondary battery. For this reason, the proportion of cobalt used as the transition metal M is preferably higher than or equal to 2.5 atomic % and lower than or equal to 34 atomic %.

Note that cobalt is not necessarily contained as the transition metal M.

Manganese is preferably contained as the transition metal M, in which case the heat resistance and chemical stability are improved. However, a too high proportion of manganese tends to decrease discharge voltage and discharge capacity. For this reason, the proportion of manganese used as the transition metal M is preferably higher than or equal to 2.5 atomic % and lower than or equal to 34 atomic %.

Note that manganese is not necessarily contained as the transition metal M.

As the transition metal M source, an aqueous solution containing the transition metal M is prepared. As the nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can be used. In this specification and the like, the term “organic acid salt” denotes a compound of a metal and an organic acid such as an acetic acid, a citric acid, an oxalic acid, a formic acid, or a butyric acid.

Similarly, as the cobalt source, an aqueous solution of cobalt salt can be used. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, as the manganese source, an aqueous solution of manganese salt can be used. As the manganese salt, manganese sulfate, manganese chloride, manganese nitrate, or a hydrate thereof can be used, for example. Furthermore, an organic acid salt of manganese typified by manganese acetate or a hydrate thereof can also be used. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. In this case, the atomic ratio of nickel, cobalt, and manganese is Ni:Co:Mn=8:1:1 or in the neighborhood thereof. The aqueous solution is acidic.

### <Step S13>

As shown in Step S13 in FIG. 6, a chelate agent may be prepared. Examples of the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. At least one of the above is dissolved in pure water and the solution is used as a chelate aqueous solution. The chelate agent serves as a complexing agent to form a chelate compound, and is preferred to a general complexing agent. Needless to say, a complexing agent other than the chelate agent may be used, and ammonia water can be used as the complexing agent. The chelate aqueous solution is preferably used, in which case generation of unnecessary crystal nuclei is suppressed and growth is promoted. Since generation of unnecessary crystal nuclei is suppressed to inhibit generation of fine particles, a composite hydroxide with good particle size distribution can be obtained. Furthermore, the use of the chelate aqueous solution can slow an acid-base reaction, so that the reaction gradually progresses to form a nearly spherical secondary particle. Glycine has a function of keeping the pH constant and greater than or equal to 9 and less than or equal to 10 or the vicinity of the range. A glycine aqueous solution is preferably used as the chelate aqueous solution, in which case control of the pH in the reaction vessel is facilitated in obtaining a composite hydroxide 98 described above.

### <Step S14>

Next, in Step S14 in FIG. 6, the transition metal M source and the chelate agent are mixed, so that an acid solution is formed.

### <Step S21>

Next, in Step S21 in FIG. 6, an alkaline solution is prepared. As the alkaline solution, an aqueous solution containing sodium hydroxide, potassium hydroxide, lithium hydroxide, or ammonia can be used. An aqueous solution obtained by dissolving these in pure water can be used. An aqueous solution in which two or more kinds selected from sodium hydroxide, potassium hydroxide, lithium hydroxide, and ammonia are dissolved in pure water may be used.

The pure water that is preferably used for the transition metal M source and the alkaline solution is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Step S22>

As shown in Step S22 in FIG. 6, water is preferably prepared in a reaction vessel. The water may be an aqueous solution of a chelate agent, and pure water is preferably used. The use of pure water promotes nucleation, leading to formation of a composite hydroxide with a small particle diameter. The water prepared in a reaction vessel can be referred to as an adjustment liquid or a filling liquid in the reaction vessel. For the case of using a chelate aqueous solution, the description for Step S13 can be referred to.

### <Step S31>

Next, in Step S31 in FIG. 6, an acid solution and an alkaline solution are mixed to be reacted with each other. The reaction can be referred to as a coprecipitation reaction, a neutralization reaction, or an acid-base reaction.

During the coprecipitation reaction of Step S31, the pH of the reaction system is preferably higher than or equal to 9.0 and lower than or equal to 11.5.

For example, when an alkaline solution is put in a reaction vessel and an acid solution is dropped into the reaction vessel, the pH of the aqueous solution in the reaction vessel is preferably kept in the above range. The same applies to a case where the acid solution is put in the reaction vessel and the alkaline solution is dropped thereinto. The dropping rate of the acid solution or the alkaline solution is preferably lower than or equal to 0.01 m/min when 200 mL to 350 mL of the solution is in the reaction vessel, in which case the pH conditions can be easily controlled. The reaction vessel contains a reaction container or the like.

The aqueous solution in the reaction vessel is preferably stirred with a stirring means. The stirring means includes a stirrer, an impeller, or the like. The impeller can have two to six agitator blades; for example, in the case where four agitator blades are provided, they are preferably arranged to make a cross shape seen from above. The rotation number of the stirring means is preferably greater than or equal to 800 rpm and less than or equal to 1200 rpm. A baffle plate may be provided in the reaction vessel to change the stirring direction and the rate of flow. The provision of a baffle plate improves mixing efficiency and allows synthesis of composite hydroxide particles with more uniform sizes or the like.

The temperature of the reaction vessel is preferably controlled to be higher than or equal to 50° C. and lower than or equal to 90° C. After the temperature of the reaction vessel falls within the above temperature range, dropping of the alkaline solution or the acid solution is preferably started.

The reaction vessel preferably has an inert atmosphere. In this case, nitrogen or argon can be used as the inert atmosphere. In the case of the nitrogen atmosphere, a nitrogen gas is preferably introduced at a flow rate of 0.5 L/min to 2 L/min.

In the reaction vessel, a reflux condenser is preferably placed. The nitrogen gas can be released from the reaction vessel and water vapor can be returned to the reaction vessel with use of the reflux condenser.

Through the above-described coprecipitation reaction, the composite hydroxide 98 containing the transition metal M is precipitated.

### <Step S32>

Filtration is preferably performed to collect the composite hydroxide 98 as shown in Step S32 in FIG. 6. Suction filtration is preferred for the filtration. In the filtration, an organic solvent (e.g., acetone) may be used after a reaction product precipitated in the reaction vessel is washed with pure water.

### <Step S33>

As shown in Step S33 in FIG. 6, the composite hydroxide 98 after the filtration is preferably dried. For example, drying is performed in a vacuum at higher than or equal to 60° C. and lower than or equal to 200° C. for longer than or equal to 0.5 hours and shorter than or equal to 20 hours. For example, the drying can be performed for 12 hours. In this manner, the composite hydroxide 98 can be obtained.

In this manner, the composite hydroxide 98 containing the transition metal M can be obtained. In this specification and the like, the composite hydroxide 98 denotes a hydroxide of a plurality of metals. The composite hydroxide 98 can be referred to as a precursor of the positive electrode active material 100.

### <Step S41>

Next, in Step S41 in FIG. 7, a lithium source is prepared. Since a process of adding a lithium source and performing heating is performed a plurality of times at this time, the amount of lithium prepared in Step S41 is smaller than the final required amount of lithium. For example, when the total number of atoms of nickel, cobalt, and manganese is 1, lithium can be greater than or equal to 0.5 and less than or equal to 0.9 (atomic ratio), and is preferably 0.7 (atomic ratio).

As the lithium source, for example, lithium hydroxide, lithium carbonate, or lithium nitrate can be used. In particular, a material having a low melting point among lithium compounds, such as lithium hydroxide (melting point: 462° C.), is preferably used. Since a positive electrode active material containing nickel at a high proportion easily causes cation mixing as compared with lithium cobalt oxide or the like, heating in Step S43 and the like needs to be performed at low temperatures. Therefore, it is preferable to use a material having a low melting point.

The particle diameter of the lithium source is preferably small because it facilitates a favorable reaction. A lithium source microparticulated by fluidized bed jet milling can be used, for example. The particle diameter here refers to a median diameter.

### <Step S42>

Next, in Step S42 in FIG. 7, the composite hydroxide 98 and the lithium source are mixed. The mixing can be performed by a dry process or a wet process. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/sec and less than or equal to 2000 mm/sec in order to inhibit contamination from the media or the material. The cobalt compound and the lithium compound are sometimes pulverized during the mixing.

### <Step S43>

Then, heating is performed on the mixture of the composite hydroxide 98 and the lithium source. For distinction between the heating steps, Step S43, Step S53, and Step S55 in FIG. 7 may be referred to as first heating, second heating, and third heating, respectively.

A muffle furnace, a roller hearth kiln, a rotary kiln, or the like can be used as a firing device for the heating. A crucible, a sagger, a setter, or a container used in the heating is preferably made of a material that hardly releases impurities. For example, a crucible made of aluminum oxide with a purity of 99.9% is preferably used. In the case of mass production, a sagger made of mullite cordierite (Al₂O₃, SiO₂, and MgO) is preferably used, for example.

The heating in Step S43 is preferably performed at a temperature higher than or equal to 400° C. and lower than or equal to 750° C., further preferably higher than or equal to 650° C. and lower than or equal to 750° C. The time for the heating in Step S43 is preferably longer than or equal to 1 hour and shorter than or equal to 30 hours, further preferably longer than or equal to 2 hours and shorter than or equal to 20 hours.

The heating is preferably performed in an atmosphere containing oxygen or an oxygen-containing atmosphere that is what is called dry air with little water (e.g., with a dew point lower than or equal to −50° C., preferably lower than or equal to −80° C.).

Furthermore, a crushing step is preferably performed in Step S44 after the heating. The crushing can be performed in a mortar, for example. Furthermore, classification may be performed using a sieve. With the crushing step, the particle diameter and/or the shape of the positive electrode active material 100 can be uniformized. Through the above steps, a composite oxide is obtained (Step S45).

### <Step S51>

Next, in Step S51, a lithium source is prepared. At this time, the lithium source is prepared so that the total amount of lithium in this step and lithium in Step S41 is the final required amount of lithium. For example, when the total number of atoms of nickel, cobalt, and manganese is 1 and lithium is 0.7 (atomic ratio) in Step S41, 0.31 (atomic ratio) is preferably prepared in Step S51. Here, the final required amount of lithium is 1.01 (atomic ratio) when the total number of atoms of nickel, cobalt, and manganese is 1; however, one embodiment of the present invention is not limited thereto. The final required amount of lithium when the total number of atoms of nickel, cobalt, and manganese is 1 is preferably greater than or equal to 0.95 and less than or equal to 1.25 (atomic ratio), further preferably greater than or equal to 1.00 and less than or equal to 1.10 (atomic ratio). The description in Step S41 except for the amount of the lithium source to be prepared can be referred to.

Although a method in which the lithium source is added twice in Step S41 and Step S51 and heating is performed after each of the step is described with reference to FIG. 7, one embodiment of the present invention is not limited thereto. The lithium source may be added three or more times and heating may be performed after each of the step.

### <Step S52>

Then, the composite oxide obtained in Step S45 and the lithium source are mixed. For the mixing, the description of Step S42 can be referred to.

### <Step S53>

Subsequently, heating is performed on the mixture of the composite hydroxide 98 and the lithium source. The heating in Step S53 is preferably performed at sufficiently high temperatures to increase the crystallite size of the positive electrode active material 100. The temperature range may depend on the composition of the transition metal M.

In the case where the proportion of nickel used as the transition metal M is high, e.g., higher than or equal to 70%, the heating temperature is preferably higher than or equal to 750° C., further preferably higher than or equal to 800° C., still further preferably higher than or equal to 850° C., for example. Meanwhile, too high temperatures might cause reduction of the transition metal M such as nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel used as the transition metal M is higher than or equal to 40% and lower than 70%, the heating temperature is preferably higher than or equal to 900° C., further preferably higher than or equal to 950° C., still further preferably around 970° C., for example. Meanwhile, too high temperatures might cause the above disadvantage; accordingly, the heating temperature is preferably lower than or equal to 1020° C., further preferably lower than or equal to 990° C. For the other conditions of the heating, the description of Step S43 can be referred to.

Furthermore, a crushing step is preferably performed in Step S54 after the heating. The description of Step S44 can be referred to for the crushing.

### <Step S55>

In addition, the heating in Step S55 is preferably performed. The heating can reduce the residue of the lithium source or the like. The heating in Step S55 is preferably performed at a temperature higher than or equal to 400° C. and lower than or equal to 900° C., further preferably higher than or equal to 750° C. and lower than or equal to 850° C. The time for the heating in Step S52 is preferably longer than or equal to 1 hour and shorter than or equal to 30 hours, further preferably longer than or equal to 2 hours and shorter than or equal to 20 hours. Note that the heating in Step S55 is not necessarily performed. For the other conditions of the heating, the description of Step S43 can be referred to.

Furthermore, a crushing step is preferably performed in Step S56 after the heating. The description of Step S44 can be referred to for the crushing.

Although a method in which heating is performed twice in Step S53 and Step S55 after the lithium source is mixed in Step S51 is described with reference to FIG. 7, one embodiment of the present invention is not limited thereto. Heating may be performed three or more times.

Through the above steps, the positive electrode active material 100 can be formed.

### <<Formation Method 2 of Positive Electrode Active Material>>

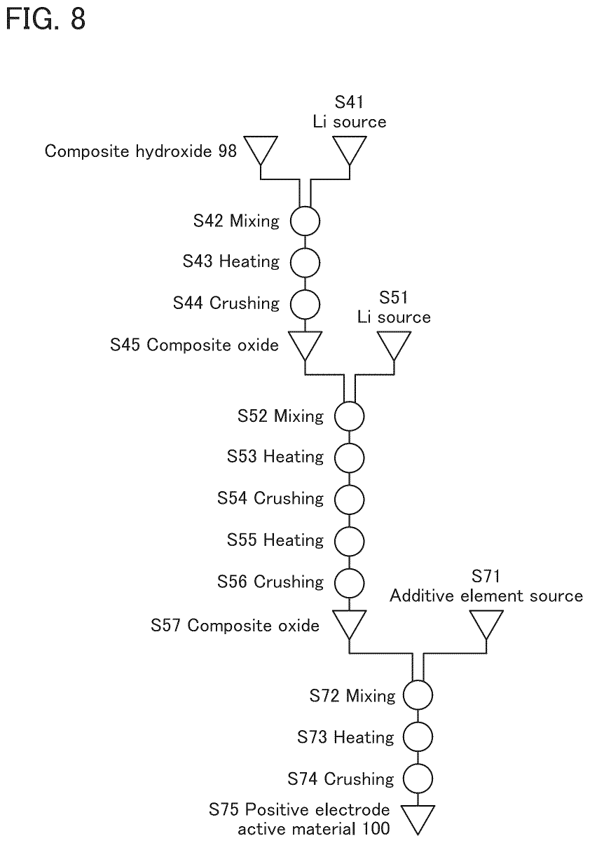

Formation method 2 of the positive electrode active material 100 will be described with reference to FIG. 6 and FIG. 8. The positive electrode active material 100 formed by Formation method 2 contains an additive element. Steps different from those in Formation method 1 are mainly described, and for the other steps, the description of Formation method 1 can be referred to.

### <Step S71>

In Step S71 in FIG. 8, an additive element source is prepared.

As the additive element, one or two or more selected from magnesium, aluminum, calcium, titanium, zirconium, fluorine, vanadium, iron, manganese, chromium, niobium, arsenic, zinc, silicon, sulfur, phosphorus, boron, bromine, and beryllium can be used, for example.

As the magnesium source, an organic compound containing magnesium such as magnesium fluoride, magnesium hydroxide, magnesium carbonate, acetylacetone magnesium (a dihydrate), magnesium lactate, or phthalocyanine magnesium(II) can be used, for example.

As the aluminum source, an organic compound containing aluminum such as aluminum hydroxide, aluminum fluoride, aluminum alkoxide, acetylacetone aluminum, or aluminum lactate can be used, for example.

### <Step S72>

The additive element source and a composite oxide with a large crystallite size obtained through steps similar to those in Formation method 1 are mixed.

Note that although this embodiment describes a formation method in which the additive element is mixed in Step S72, one embodiment of the present invention is not limited thereto. The additive element may be mixed in another step. For example, the additive element may be mixed concurrently with the lithium source in Step S42 and Step S52. The additive element may be mixed concurrently with the transition metal Msource in Step S14.

### <Step S73>

Next, heating is performed on a mixture of the additive element source and the composite oxide. The heating in Step S73 is preferably performed at a temperature higher than or equal to 400° C. and lower than or equal to 900° C., further preferably higher than or equal to 750° C. and lower than or equal to 850° C. The time for the heating in Step S73 is preferably longer than or equal to 0.5 hours and shorter than or equal to 30 hours, further preferably longer than or equal to 1 hour and shorter than or equal to 10 hours. For the other conditions of the heating, the description of Step S43 can be referred to.

Furthermore, a crushing step is preferably performed in Step S74 after the heating. The description of Step S44 can be referred to for the crushing.

Through the above steps, the positive electrode active material 100 can be formed (Step S75).

### <<Formation Method 3 of Positive Electrode Active Material>>

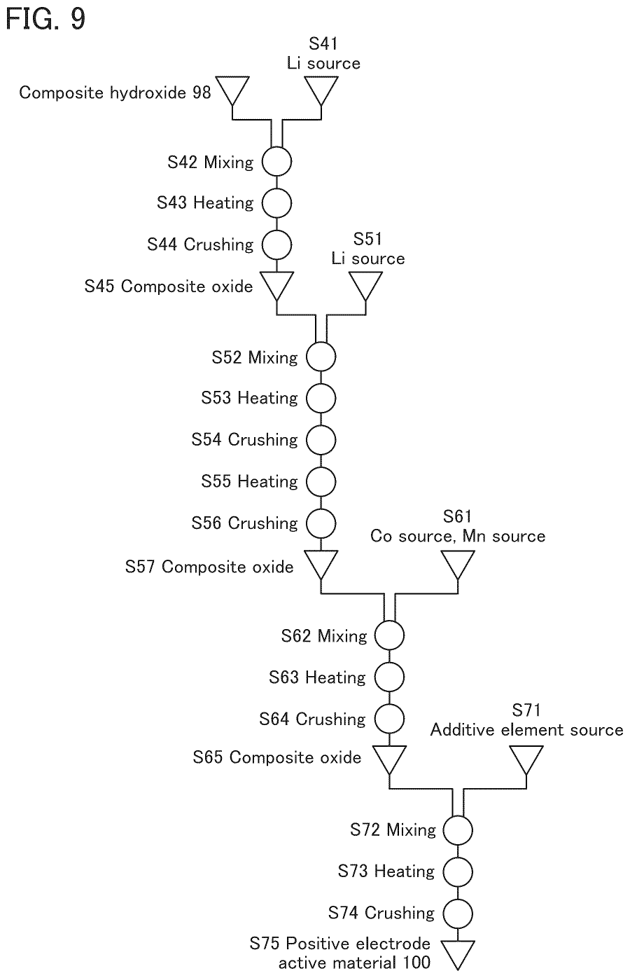

Formation method 3 of the positive electrode active material 100 will be described with reference to FIG. 6 and FIG. 9. The positive electrode active material 100 formed by Formation method 3 contains an additive element, and has a higher proportion of the number of atoms of at least one of cobalt and manganese in the surface portion than in the inner portion. Steps different from those in Formation method 2 are mainly described, and for the other steps, the description of Formation method 2 can be referred to.

### <Step S61>

In Step S61 in FIG. 9, at least one of a cobalt source and a manganese source is prepared.

As the cobalt source, an organic compound containing cobalt such as cobalt oxide, cobalt hydroxide, or cobalt alkoxide can be used, for example.

As the manganese source, an organic compound containing manganese such as manganese oxide, manganese hydroxide, or manganese alkoxide can be used, for example.

Note that a composite hydroxide may be prepared in Step S61. For example, a composite hydroxide containing cobalt and manganese may be prepared as the cobalt source and the manganese source. Alternatively, a nickel-manganese-cobalt hydroxide having a lower proportion of nickel than the composite hydroxide formed in FIG. 6 may be prepared.

### <Step S62>

At least one of the cobalt source and the manganese source and a composite oxide with a large crystallite size obtained through steps similar to those in Formation method 1 are mixed. There is no particular limitation on the mixing method. For example, in the case where the cobalt source and/or the manganese source are alkoxide, a sol-gel method can be employed. In the case where the cobalt source and/or the manganese source are composite hydroxides, a mechanochemical method can be employed.

### <Step S63>

Next, heating is performed on a mixture of the cobalt source and/or the manganese source and the composite oxide.

Furthermore, a crushing step is preferably performed in Step S64 after the heating. The description of Step S44 can be referred to for the crushing.

After the composite oxide is formed through the above steps, the additive element is mixed and heating is performed in a manner similar to that in Formation method 2 of the positive electrode active material, whereby the positive electrode active material 100 can be formed.

Note that although the method in which at least one of the cobalt source and the manganese source is added before the additive element source is added is described with reference to FIG. 6 and FIG. 9, one embodiment of the present invention is not limited thereto. At least one of the cobalt source and the manganese source may be added after the additive element source is added, or may be added together with the additive element source. When the composite hydroxide 98 in FIG. 6 is formed, the composition of the transition metal Mmay be varied between the inner portion and the surface portion. In this case, for example, by changing an acid solution having a high proportion of nickel in the transition metal M to an acid solution having a low proportion of nickel, the proportion of nickel can be varied between the inner portion and the surface portion.

This embodiment can be used in appropriate combination with any of the other embodiments.

### Embodiment 3

In this embodiment, components included in a lithium-ion battery are described.

### [Positive Electrode]

A positive electrode includes a positive electrode active material layer and a positive electrode current collector. The positive electrode active material layer includes a positive electrode active material and may further contain at least one of a conductive material and a binder. As the positive electrode active material, the positive electrode active material described in Embodiment 1 can be used.

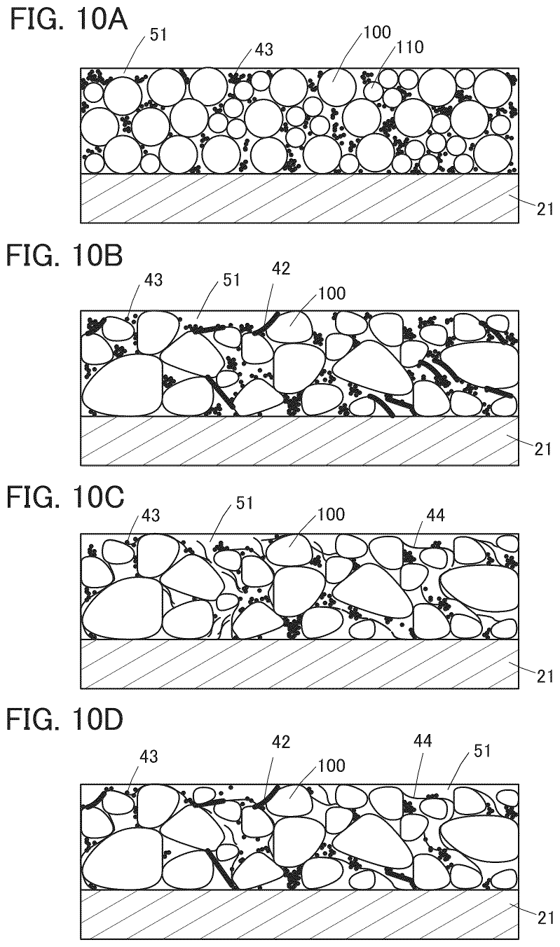

FIG. 10A shows an example of a schematic cross-sectional view of the positive electrode.

Metal foil can be used as a positive electrode current collector 21, for example. The positive electrode can be formed by applying slurry onto the metal foil and drying the slurry. Note that pressing may be performed after drying. The positive electrode is a component obtained by forming an active material layer over the positive electrode current collector 21.

Slurry refers to a material solution that is used to form an active material layer over the positive electrode current collector 21 and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

The positive electrode active material 100 has functions of taking and releasing lithium ions in accordance with charging and discharging. For the positive electrode active material 100 used as one embodiment of the present invention, a material with less deterioration due to charging and discharging even at high charge voltage can be used. In this specification and the like, unless otherwise specified, a charge voltage is shown with reference to the potential of a lithium metal. In this specification and the like, high charge voltage is a charge voltage, for example, higher than or equal to 4.5 V, preferably higher than or equal to 4.55 V, further preferably higher than or equal to 4.6 V, higher than or equal to 4.65 V, or higher than or equal to 4.7 V.

For the positive electrode active material 100 used as one embodiment of the present invention, any material can be used as long as it has less deterioration due to charging and discharging even at high charge voltage, and any of the materials described in Embodiment 1 or Embodiment 2 can be used. Note that for the positive electrode active material 100, two or more kinds of materials having different particle diameters can be used as long as the materials have less deterioration due to charging and discharging even at high charge voltage.

A conductive material is also referred to as a conductivity-imparting agent or a conductive additive, and a carbon material can be used as the conductive material. A conductive material is attached between a plurality of active materials, whereby the plurality of active materials are electrically connected to each other, and the conductivity increases. Note that in this specification and the like, the term “attach” refers not only to a state where an active material and a conductive material are physically in close contact with each other, and is a concept including the following cases, for example: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Specific examples of carbon materials that can be used as the conductive material include carbon black (e.g., furnace black or acetylene black).

FIG. 10A to FIG. 10D show examples of a positive electrode.

FIG. 10A illustrates carbon black 43 that is an example of a conductive material and an electrolyte 51 included in a void portion positioned between the positive electrode active materials 100, and shows an example in which a second positive electrode active material 110 is also included in addition to the positive electrode active material 100.

In the positive electrode of the secondary battery, a binder (a resin) may be mixed in order to fix the positive electrode current collector 21 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of binder mixed is preferably reduced to a minimum.

Although FIG. 10A shows an example in which the positive electrode active material 100 has a spherical shape, there is no particular limitation. The cross-sectional shape of the positive electrode active material 100 may be an ellipse, a rectangle, a trapezoid, a triangle, a quadrilateral with rounded corners, or an asymmetrical shape, for example. For example, FIG. 10B shows an example in which the positive electrode active material 100 has a polygon shape with rounded corners.

In the positive electrode in FIG. 10B, graphene 42 is used as a carbon material used as the conductive material. In FIG. 10B, a positive electrode active material layer including the positive electrode active material 100, the graphene 42, and the carbon black 43 is formed over the positive electrode current collector 21.

In the step of mixing the graphene 42 and the carbon black 43 to obtain electrode slurry, the weight of mixed carbon black is preferably 1.5 times to 20 times, further preferably 2 times to 9.5 times the weight of graphene.

When the graphene 42 and the carbon black 43 are mixed in the above range, the carbon black 43 is excellent in dispersion stability and an aggregated portion is unlikely to be generated at the time of preparing slurry. Furthermore, when the graphene 42 and the carbon black 43 are mixed in the above range, the electrode density can be higher than that of a positive electrode using only the carbon black 43 as a conductive material. As the electrode density is higher, the capacity per unit weight can be higher. Specifically, the density of the positive electrode active material layer measured by gravimetry can be higher than or equal to 3.5 g/cc.

The electrode density is lower than that of a positive electrode containing only graphene as a conductive material, but when a first carbon material (graphene) and a second carbon material (acetylene black) are mixed in the above range, fast charging can be achieved. Thus, use of such a mixed conductive material for secondary batteries for vehicles is particularly effective.

FIG. 10C shows an example of a positive electrode in which carbon fiber 44 is used instead of graphene. FIG. 10C shows an example different from FIG. 10B. With use of the carbon fiber 44, aggregation of carbon black 43 can be prevented and the dispersibility can be increased.

In FIG. 10C, the region that is not filled with the positive electrode active material 100, the carbon fiber 44, or the carbon black 43 represents a space or a binder.

FIG. 10D shows another example of a positive electrode. FIG. 10C shows an example in which the carbon fiber 44 is used in addition to the graphene 42. With use of both the graphene 42 and the carbon fiber 44, aggregation of carbon black such as the carbon black 43 can be prevented and the dispersibility can be further increased.

In FIG. 10D, the region that is not filled with the positive electrode active material 100, the carbon fiber 44, the graphene 42, or the carbon black 43 represents a space or a binder.

A secondary battery can be manufactured by using any one of the positive electrodes in FIG. 10A to FIG. 10D; setting, in a container (e.g., an exterior body or a metal can) or the like, a stack in which a separator is provided over the positive electrode and a negative electrode is provided over the separator; and filling the container with an electrolyte solution.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As the material having a significant viscosity modifying effect, for instance, a water-soluble polymer is preferably used. As the water-soluble polymer having a significant viscosity modifying effect, the above-mentioned polysaccharide or, for instance, starch or a cellulose derivative such as carboxymethyl cellulose (CMC), methyl cellulose, ethyl cellulose, hydroxypropyl cellulose, diacetyl cellulose, or regenerated cellulose can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Conductive Material>

A conductive material is also referred to as a conductivity-imparting agent or a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and is a concept including the following cases, for example: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Active material layers such as the positive electrode active material layer and the negative electrode active material layer preferably contain a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

The content of the conductive material to the total volume of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### <Positive Electrode Current Collector>

The positive electrode current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 m and less than or equal to 30 m.

### [Negative Electrode]

The negative electrode includes a negative electrode active material layer and a negative electrode current collector. The negative electrode active material layer includes a negative electrode active material, and may further contain a conductive material and a binder.

### <Negative Electrode Active Material>

As a negative electrode active material, for example, an alloy-based material or a carbon material can be used.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reaction by an alloying and a dealloying reaction with lithium and a compound containing the element, for example, are referred to as alloy-based materials in some cases.

In this specification and the like, “SiO” refers, for example, to silicon monoxide. Alternatively, SiO can be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LixC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material at the completion of the fabrication of the battery may be used. As the negative electrode that does not contain a negative electrode active material, for example, a negative electrode can be used in which only a negative electrode current collector is included at the completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case of using the negative electrode that does not contain a negative electrode active material, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. Among them, a film of the polymer-based solid electrolyte can be uniformly formed over the negative electrode current collector relatively easily, and thus is suitable as the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case of using the negative electrode that does not contain a negative electrode active material, a negative electrode current collector having unevenness can be used. In the case of using the negative electrode current collector having unevenness, a depression of the negative electrode current collector becomes a cavity in which lithium contained in the negative electrode current collector is easily deposited, so that the lithium can be inhibited from having a dendrite-like shape when being deposited.

For the conductive material and the binder that can be contained in the negative electrode active material layer, materials similar to those of the conductive material and the binder that can be contained in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The use of one or more kinds of ionic liquids (room temperature molten salts) which have features of non-flammability and non-volatility as the solvent of the electrolyte solution can prevent a secondary battery from exploding and/or catching fire even when the internal temperature increases due to an internal short circuit or overcharging of the secondary battery, for example. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

As the electrolyte solution used for the secondary battery, it is preferable to use an electrolyte solution that is highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), a dinitrile compound such as succinonitrile or adiponitrile, fluorobenzene, or ethylene glycol bis(propionitrile) ether may be added to the electrolyte solution. The concentration of the material to be added in the whole solvent is, for example, higher than or equal to 0.1 wt % and lower than or equal to 5 wt %. It is particularly preferable to use VC or LiBOB because it facilitates formation of a favorable coating portion. Note that the additive agent may become a coating film attached to an active material surface in aging treatment of a secondary battery. Thus, in a secondary battery that has been charged and discharged even a little, at least part of the additive agent is not detected in the electrolyte solution in some cases.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### [Separator]

When the electrolyte includes an electrolyte solution, a separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Embodiment 4

This embodiment describes examples of shapes of a secondary battery including a positive electrode formed by the formation method described in the above embodiment.

### [Coin-Type Secondary Battery]

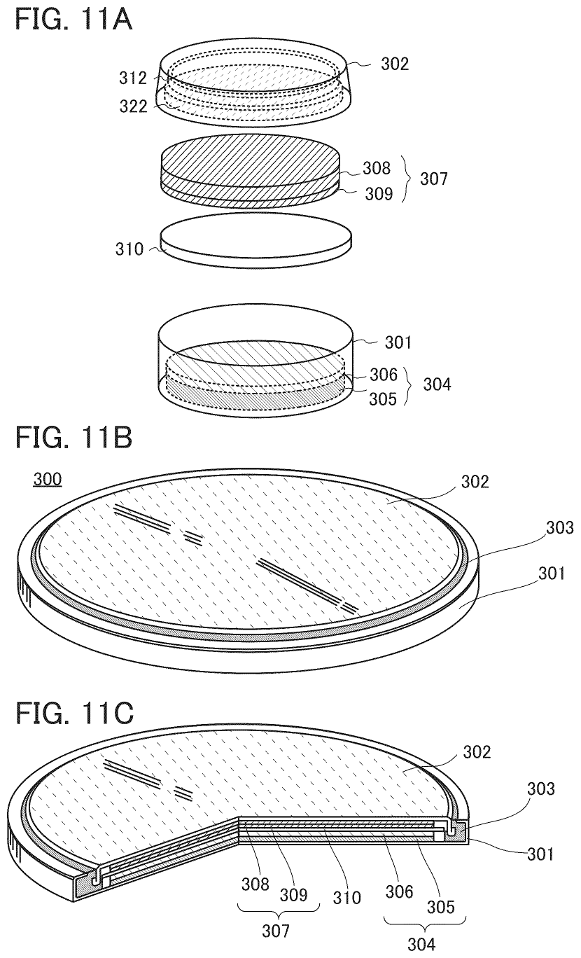

An example of a coin-type secondary battery is described. FIG. 11A is an exploded perspective view of a coin-type (single-layer flat type) secondary battery, FIG. 11B is an external view thereof, and FIG. 1C is a cross-sectional view thereof. Coin-type secondary batteries are mainly used in small electronic devices.

For easy understanding, FIG. 11A is a schematic view illustrating overlap (a vertical relation and a positional relation) between components. Thus, FIG. 11A and FIG. 11B do not completely correspond with each other.

In FIG. 11A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 11A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 11B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 11C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high discharge capacity and excellent cycle performance.

### [Cylindrical Secondary Battery]

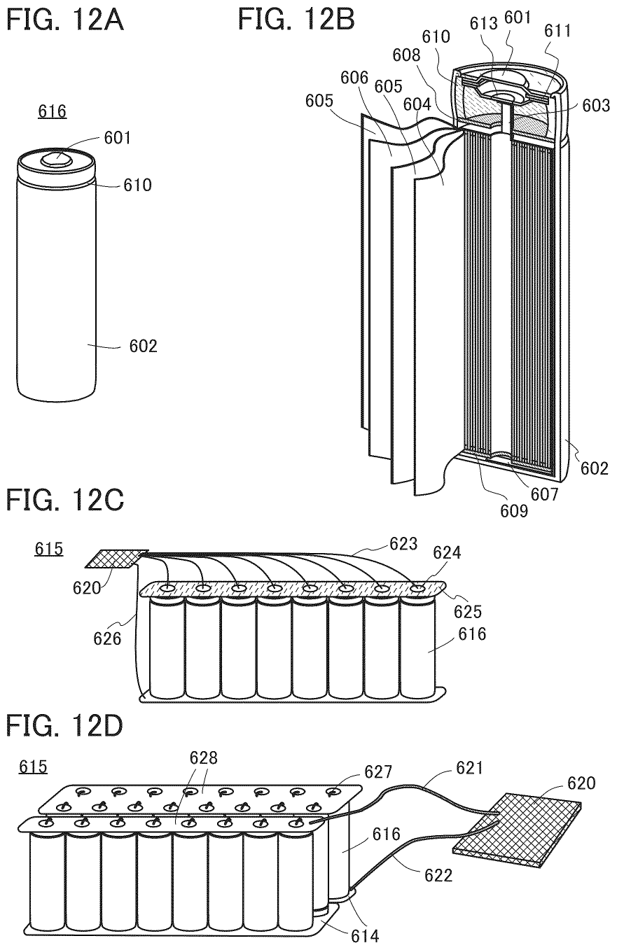

An example of a cylindrical secondary battery is described with reference to FIG. 12A. As illustrated in FIG. 12A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 12B schematically illustrates a cross section of a cylindrical secondary battery. The cylindrical secondary battery illustrated in FIG. 12B includes the positive electrode cap (battery cap) 601 on the top surface and the battery can (outer can) 602 on the side surface and bottom surface. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not shown) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material 100 obtained in Embodiments 1, 2, and the like is used for the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 12C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 12D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 12D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

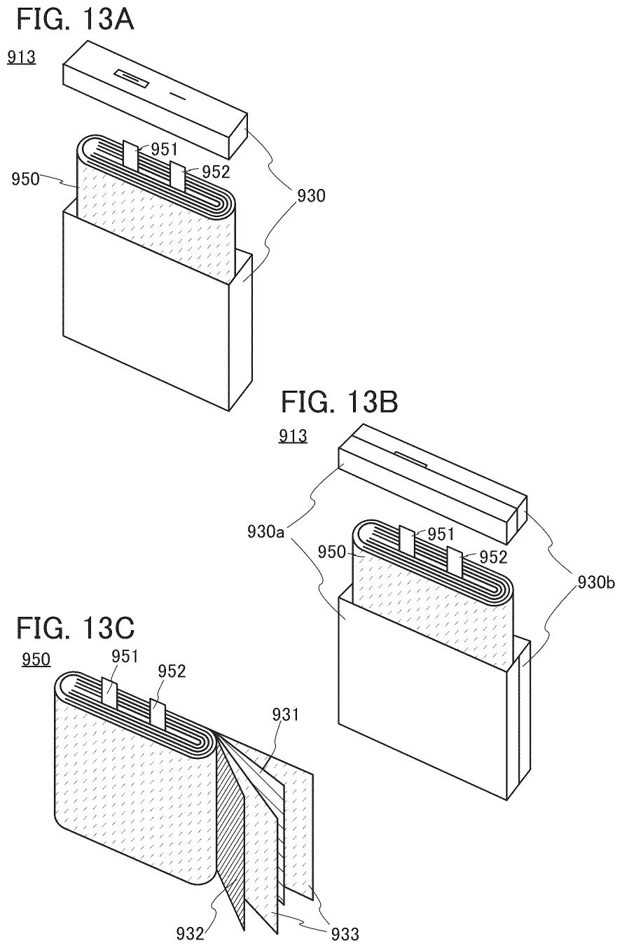

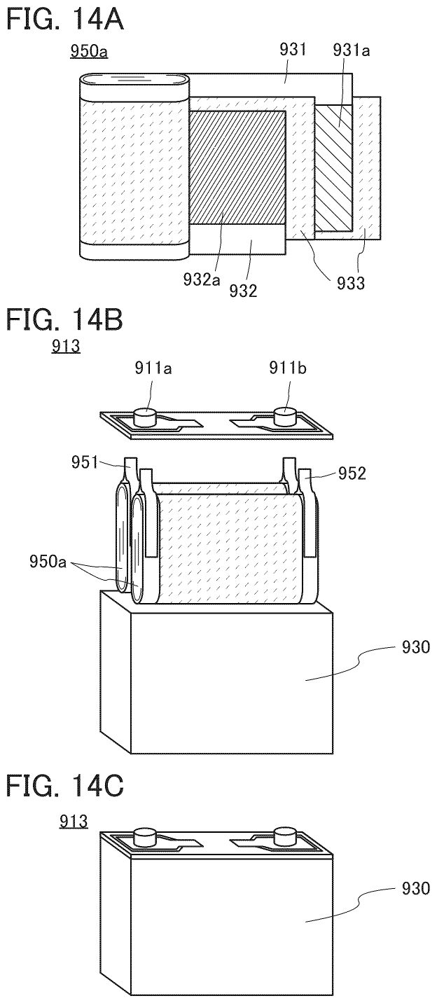

Structure examples of secondary batteries are described with reference to FIG. 13 and FIG. 14.

A secondary battery 913 illustrated in FIG. 13A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 13A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 13B, the housing 930 illustrated in FIG. 13A may be formed using a plurality of materials. For example, in the secondary battery 913 illustrated in FIG. 13B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 13C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 14, the secondary battery 913 may include a wound body 950a. The wound body 950a illustrated in FIG. 14A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1, 2, and the like is used for the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 14B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 14C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 14B, the secondary battery 913 may include a plurality of wound bodies 950a. The use of the plurality of wound bodies 950a enables the secondary battery 913 to have higher discharge capacity. The description of the secondary battery 913 illustrated in FIG. 13A to FIG. 13C can be referred to for the other components of the secondary battery 913 illustrated in FIG. 14A and FIG. 14B.

### <Laminated Secondary Battery>

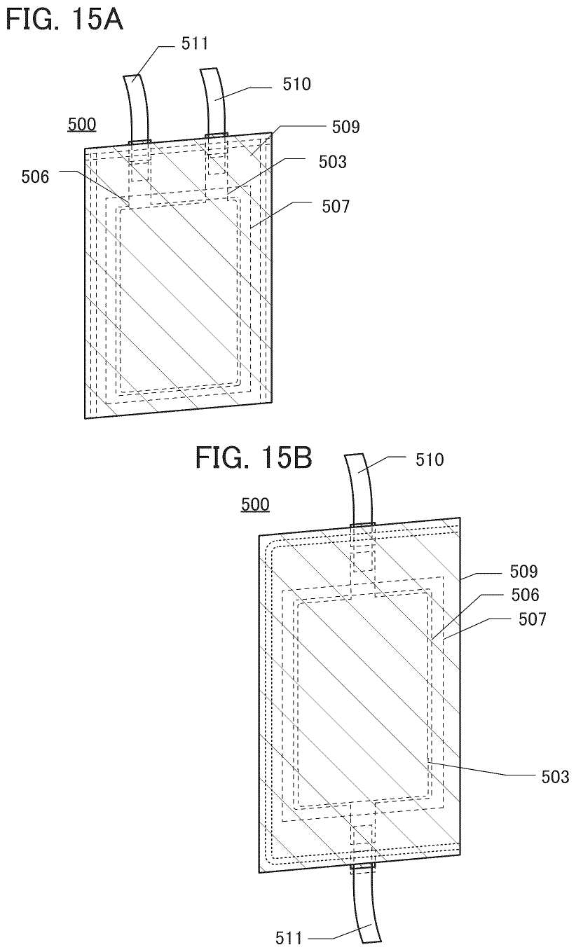

Next, examples of the appearance of a laminated secondary battery are shown in FIG. 15A and FIG. 15B. FIG. 15A and FIG. 15B each include a positive electrode 503, a negative electrode 506, a separator 507, an exterior body 509, a positive electrode lead electrode 510, and a negative electrode lead electrode 511.

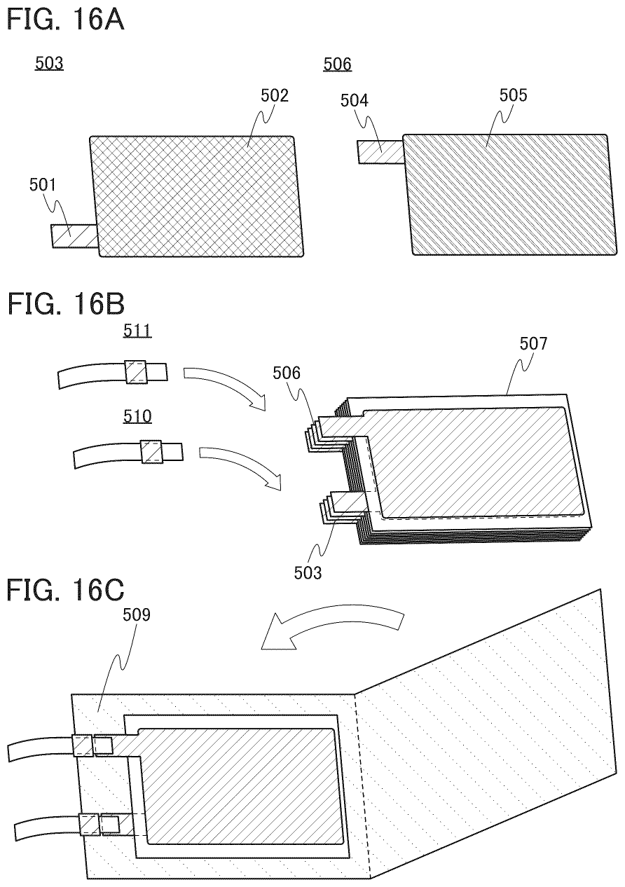

FIG. 16A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples shown in FIG. 16A.

### <Fabrication Method of Laminated Secondary Battery>

An example of a method for fabricating the laminated secondary battery whose external view is illustrated in FIG. 15A is described with reference to FIG. 16B and FIG. 16C.

First, the negative electrode 506, the separator 507, and the positive electrode 503 are stacked. FIG. 16B illustrates the negative electrodes 506, the separators 507, and the positive electrodes 503 that are stacked. Here, an example in which five negative electrodes and four positive electrodes are used is shown. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 16C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be fabricated.

The positive electrode active material 100 obtained in Embodiments 1, 2, and the like is used for the positive electrode 503, whereby the secondary battery 500 can have high capacity, high discharge capacity, and excellent cycle performance.

### Embodiment 5

In this embodiment, examples of vehicles each including the secondary battery of one embodiment of the present invention will be described.

A secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs), and the secondary battery can be used as one of the power sources provided for the automobiles. The vehicle is not limited to an automobile. Examples of vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for the vehicles.

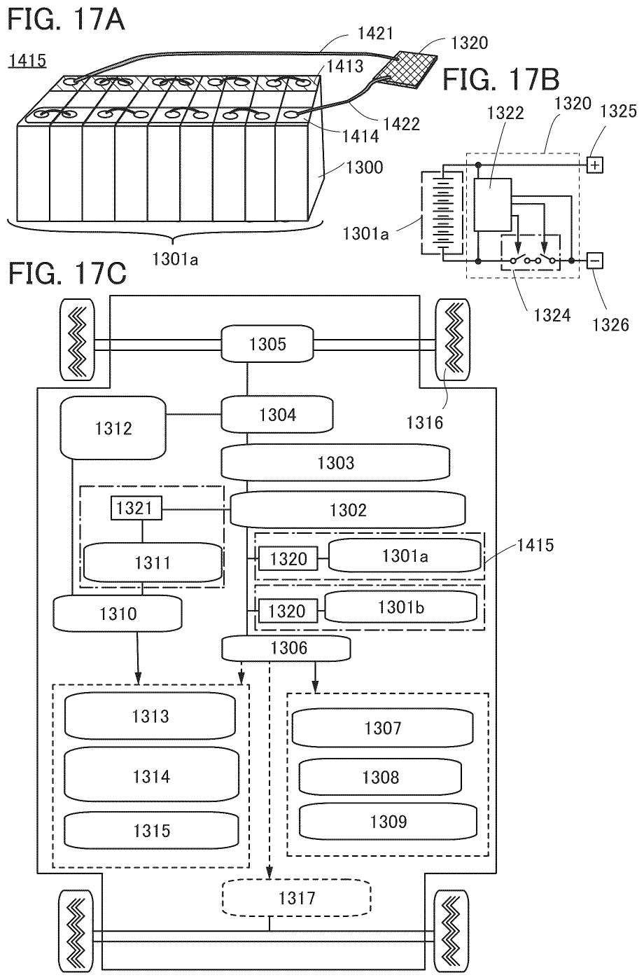

FIG. 17(C) shows an example in which the secondary battery of the present invention is used in an electric vehicle (EV). The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 13C or FIG. 14A or the stacked-layer structure illustrated in FIG. 15A or FIG. 15B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

Next, the first battery 1301a is described with reference to FIG. 17A.

FIG. 17A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M2-Zn oxide (an element M2 is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (p), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause an non-uniform distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 17B shows an example of a block diagram of the battery pack 1415 illustrated in FIG. 17A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharge and are more likely to deteriorate due to a phenomenon called sulfation. There is an advantage that the second battery 1311 can be maintenance-free when a lithium ion battery is used. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiments 1, 2, and the like can increase the operating voltage of the secondary battery, and the increase in charge voltage can increase the available capacity. Moreover, using the positive electrode active material 100 described in Embodiments 1, 2, and the like in the positive electrode can provide an automotive secondary battery having excellent cycle performance.

Next, examples in which the secondary battery of one embodiment of the present invention is mounted on a vehicle, typically a transport vehicle, are described.

Mounting the secondary battery illustrated in any of FIG. 12D, FIG. 14C, and FIG. 17A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

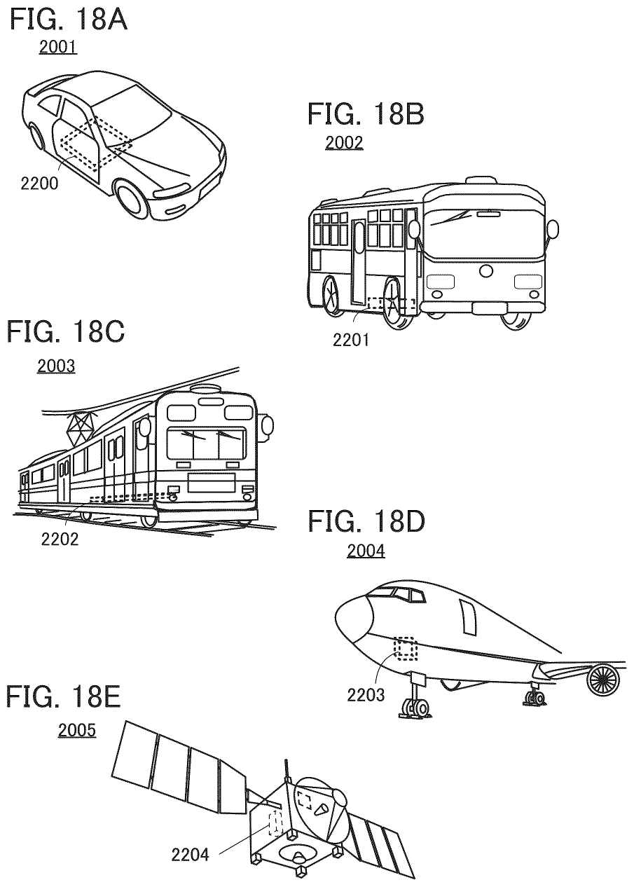

FIG. 18A to FIG. 18D show examples of transport vehicles using one embodiment of the present invention. An automobile 2001 illustrated in FIG. 18A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 18A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. A charging apparatus may be a charge station provided in a commerce facility or a household power supply. For example, with use of the plug-in system, the power storage device mounted on the automobile 2001 can be charged by being supplied with electric power from the outside. Charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 18B illustrates a large transporter 2002 having a motor controlled by electricity as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 18A except for, for example, the number of secondary batteries configuring the secondary battery module; thus, the description is omitted.

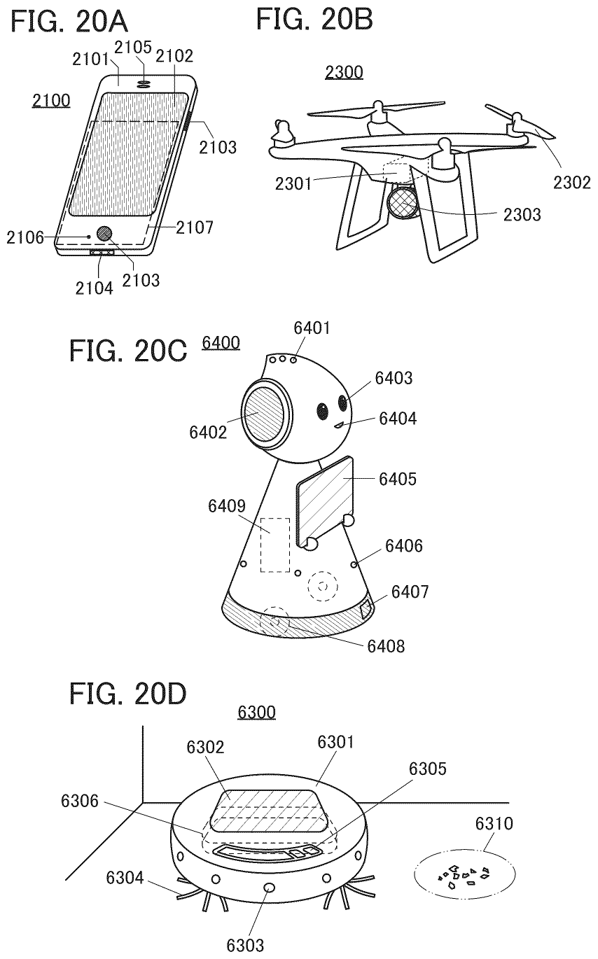

FIG. 18C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield. A battery pack 2202 has the same function as that in FIG. 20A except for, for example, the number of secondary batteries configuring the secondary battery module; thus, the description is omitted.

FIG. 18D illustrates an aircraft 2004 having a combustion engine as an example. The aircraft 2004 illustrated in FIG. 18D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, and the maximum voltage is 32 V, for example. The battery pack 2203 has the same function as that in FIG. 18A except for, for example, the number of secondary batteries configuring the secondary battery module; thus, the description is omitted.

FIG. 18E illustrates an artificial satellite 2005 including a secondary battery 2204 as an example. Since the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

### Embodiment 6

In this embodiment, examples in which the lithium-ion battery of one embodiment of the present invention is mounted on a motorcycle and a bicycle will be described as examples of mounting a secondary battery in a vehicle.

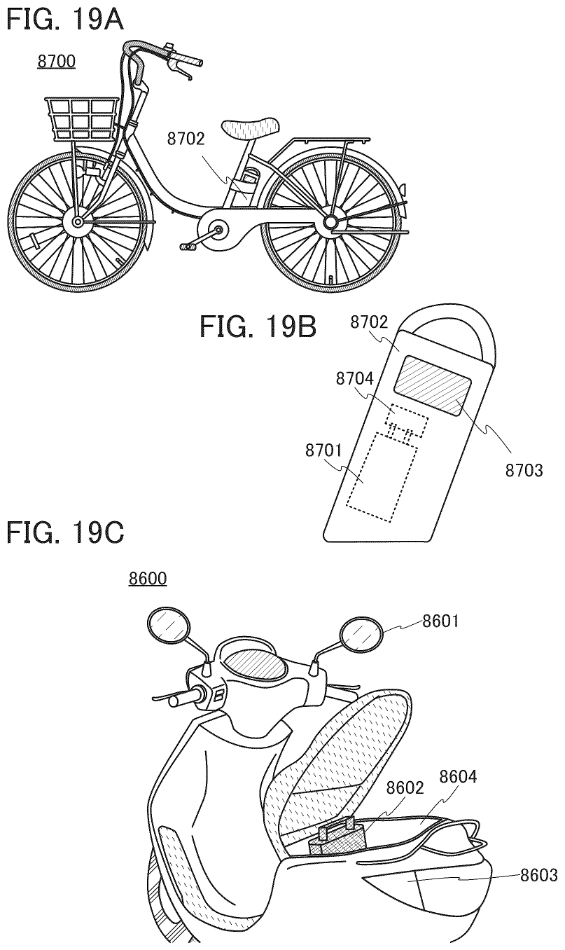

FIG. 19A shows an example of an electric bicycle using the power storage device of one embodiment of the present invention. The power storage device of one embodiment of the present invention can be used for an electric bicycle 8700 illustrated in FIG. 19A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 19B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7. The control circuit 8704 is electrically connected to a positive electrode and a negative electrode of the storage battery 8701. When the control circuit 8704 is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit 8704 can contribute greatly to elimination of accidents due to secondary batteries, such as fires.

FIG. 19C shows an example of a motorcycle using the power storage device of one embodiment of the present invention. A motor scooter 8600 illustrated in FIG. 19C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiments 1, 2, and the like can have high capacity and contribute to a reduction in size.

In the motor scooter 8600 illustrated in FIG. 19C, the power storage device 8602 can be stored in an under-seat storage unit 8604. The power storage device 8602 can be stored in the under-seat storage unit 8604 even when the under-seat storage unit 8604 is small.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

FIG. 20A shows an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 20B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1, 2, and the like has high energy density and a high level of safety, and thus can be used safely for a long time over a long period of time and is preferable as the secondary battery included in the unmanned aircraft 2300.

FIG. 20C shows an example of a robot. A robot 6400 illustrated in FIG. 20C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6409 included in the robot 6400.

FIG. 20D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6306 included in the cleaning robot 6300.

### Example 1

In this example, the positive electrode active material 100 with a large crystallite size was formed and its characteristics were evaluated.

### <Formation of Positive Electrode Active Material>

Samples formed in this example are described with reference to the formation methods shown in FIG. 6 and FIG. 7.

### <Sample 1 to Sample 5>

In Step S11 in FIG. 6, a nickel(II) sulfate as a nickel source, cobalt(II) sulfate as a cobalt source, and manganese(II) sulfate as a manganese source were prepared. In Step S13, glycine was prepared as a chelate agent. The transition metal M sources were weighed so as to be 2 mol/L and satisfy Ni:Co:Mn=8:1:1 (atomic ratio), glycine was weighed so as to be 0.200 mol/L, and pure water was added to dissolve them (Step S14), whereby an acid solution was formed.

A 5-mol/L sodium hydroxide aqueous solution was used as an alkaline solution.

As a filling liquid, pure water was used. Nitrogen was bubbled in the filling liquid at the nitrogen flow rate of 1 L/min. Note that water or an aqueous solution originally put in a reaction vessel like pure water here is sometimes referred to as a filling liquid. The filling liquid is sometimes referred to as an adjustment liquid. The filling liquid and the adjustment liquid each denote water or an aqueous solution before a reaction, that is, water or an aqueous solution in an initial state.

While the acid solution was mixed into the filling liquid at a rate of 0.10 mL/min, stirring was performed at 1000 rpm. The alkaline solution was dropped appropriately to maintain the pH of the filling liquid at 11.0. The temperature of the filling liquid was kept at 50° C. A baffle plate was provided in the reaction vessel to change the stirring direction and the rate of flow. For the coprecipitation reaction, OptiMax (produced by Mettler-Toledo. K. K.) was used.

A precipitate generated in the coprecipitation reaction was filtered with pure water and acetone and drying was performed in a vacuum drying furnace at 200° C. for 12 hours, whereby a composite hydroxide was obtained.

In Step S41 in FIG. 7, lithium hydroxide was prepared as a lithium source. The lithium hydroxide had been ground by fluidized bed jet milling. In Step S42, the composite hydroxide obtained above and the lithium source were mixed. The mixing ratio of lithium was 0.7 (atomic ratio) when the total number of atoms of nickel, cobalt, and manganese was 1.

In Step S43, the mixture of the composite hydroxide and the lithium source was heated. An aluminum oxide crucible was used for the heating, and the heating was performed in an oxygen atmosphere in a muffle furnace at 700° C. for 10 hours. The oxygen flow rate was 5 L/min, and the temperature rising rate was 100° C./hour. After that, the temperature was cooled down to room temperature, and crushing was performed (Step S44), whereby a composite oxide was obtained (Step S44).

In Step S51, lithium hydroxide similar to that in Step S41 was prepared. In Step S52, the composite oxide obtained above and the lithium source were mixed. The mixing ratio of lithium was 0.31 (atomic ratio) when the total number of atoms of nickel, cobalt, and manganese was 1. That is, the ratio of the total amount of lithium mixed in Step S42 and lithium mixed in Step S52 was 1.01 (atomic ratio) when the total number of atoms of nickel, cobalt, and manganese was 1.

In Step S53, the mixture of the composite oxide and the lithium source was heated. The heating was performed in a manner similar to that in Step S43 except that the heating temperature was 850° C. After that, the temperature was cooled down to room temperature, and crushing was performed (Step S54), whereby a positive electrode active material was obtained. This was Sample 1.

Sample 2 was formed in a manner similar to that of Sample 1 except that the heating temperature in Step S53 was 875° C.

Sample 3 was formed in a manner similar to that of Sample 1 except that the heating temperature in Step S53 was 900° C.

As a comparative example, a positive electrode active material was formed through mixing of the lithium source in one step. Specifically, the mixing ratio of lithium in Step S41 was 1.01 (atomic ratio) when the total number of atoms of nickel, cobalt, and manganese was 1, and lithium was not mixed in Step S52. Sample 4 was formed in a manner similar to that of Sample 1 except for the above.

Sample 5 was formed by subjecting Sample 4 to additional heating at 800° C. for 10 hours.

### <Sample 6 to Sample 9>

In Step S13, glycine weighed so as to be 0.100 mol/L in an acid solution was prepared. As a filling liquid, a 0.100 M glycine aqueous solution was used. The acid solution was mixed into the filling solution at a rate of 0.0443 m/min. After the coprecipitation reaction, the liquid temperature was adjusted to 25° C., filtration with pure water was performed, and then filtration with acetone was performed.

Sample 6, Sample 7, Sample 8, and Sample 9 were formed through additional heating at 800° C. for 10 hours (Step S55) after Step S54 and crushing (Step S56). The heating was performed in a manner similar to that in Step S43 except for the heating temperature. Sample 6 to Sample 9 were formed under conditions similar to those of Sample 1 to Sample 4 except for the additional heating and crushing.

### <Sample 21>

Sample 21 was formed in a manner similar to that of Sample 8 except that heating at 800° C. was performed again for 2 hours after the heating in Step S55 and the cooling.

Table 1 shows the formation conditions of Sample 1 to Sample 9 and Sample 21.

TABLE 1

| | Formation conditions | | | | | | Crystallite |
|---|---|---|---|---|---|---|---|
| | Composite | Li | S43 | S53 | S55 | | size |
| | hydroxide | mixing | heating | heating | heating | Heating | (nm) |
| Sample 1 | Ni_{0.8}Co_{0.1}Mn_{0.1}(OH)₂ | S42, S52 | 700° C., | 850° C., | — | — | 207 |
| | | | 10 hr | 10 hr | | | |
| Sample 2 | | | | 875° C., | | | 226 |
| | | | | 10 hr | | | |
| Sample 3 | | | | 900° C., | | | 218 |
| | | | | 10 hr | | | |
| Sample 4 | | S42 | | 800° C., | | | 129 |
| (comparative | | | | 10 hr | | | |
| example) | | | | | | | |
| Sample 5 | | | | 800° C., | 800° C., | | 139 |
| (comparative | | | | 10 hr | 10 hr | | |
| example) | | | | | | | |
| Sample 6 | Ni_{0.8}Co_{0.1}Mn_{0.1}(OH)₂ | S42, S52 | | 850° C., | 800° C., | | 178 |
| | | | | 10 hr | 10 hr | | |
| Sample 7 | | | | 875° C., | | | 241 |
| | | | | 10 hr | | | |
| Sample 8 | | | | 900° C., | | | 268 |
| | | | | 10 hr | | | |
| Sample 9 | | S42 | | 800° C., | — | | 106 |
| (comparative | | | | 10 hr | | | |
| example) | | | | | | | |
| Sample 21 | Ni_{0.8}Co_{0.1}Mn_{0.1}(OH)₂ | S42, S52 | | 900° C., | 800° C., | 800° C., | — |
| | | | | 10 hr | 10 hr | 2 hr | |

### <SEM>

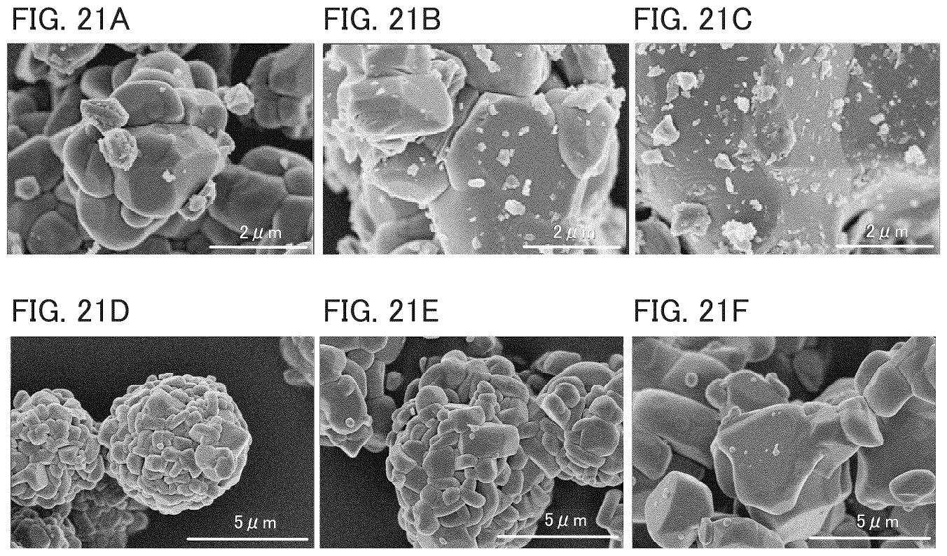

FIG. 21A shows a SEM image of Sample 1, FIG. 21B shows a SEM image of Sample 2, FIG. 21C shows a SEM image of Sample 3, FIG. 21D shows a SEM image of Sample 6, FIG. 21E shows a SEM image of Sample 7, and FIG. 21F shows a SEM image of Sample 8. Each sample was found to be a positive electrode active material with a large primary particle. In each of Sample 1 to Sample 3 formed not through the heating in S55, a material being attached to the surface of the positive electrode active material and supposed to be a residue of the lithium source or the like was observed. Meanwhile, in each of Sample 6 to Sample 8 formed through the heating in S55, a smooth surface with almost no residue was observed.

### <Crystallite Size>

The crystallite size of each of Sample 1 to Sample 9 was calculated by XRD analysis. The XRD apparatus and the calculation method were as described above in Embodiment 1. Table 1 also shows the crystallite sizes.

As shown in Table 1, Sample 1 to Sample 3 and Sample 6 to Sample 8 formed through addition of the lithium source in a plurality of steps each had a larger crystallite size than those of Sample 4, Sample 5, and Sample 9 formed through addition of the lithium source in one step. The samples formed through addition of the lithium source in one step each had a crystallite size of less than 140 nm, whereas the samples formed through addition of the lithium source in a plurality of steps each had a crystallite size of greater than or equal to 140 nm, more specifically, greater than or equal to 150 nm.

### <Charge and Discharge Rate Characteristics of Half Cells>

Half cells were assembled using the positive electrode active materials of Sample 7 to Sample 9, and charge and discharge rate characteristics were evaluated. The performance of the positive electrode alone is clarified by the evaluation of the cycle performance of the half cell.

The conditions of the half cells are described below. The above-described positive electrode active materials were prepared first, acetylene black (AB) was prepared as a conductive material, and polyvinylidene fluoride (PVDF) was prepared as a binding agent. Slurry was formed by mixing the positive electrode active material, AB, and PVDF at the positive electrode active material:AB:PVDF=95:3:2 (weight ratio), and the slurry was applied to an aluminum current collector. As a solvent of the slurry, NMP was used.

After the slurry was applied to the current collector, the solvent was volatilized. Through the above process, a positive electrode was obtained. In the positive electrode, the loading amount of the active material was approximately 7 mg/cm².

As an electrolyte solution, a solution which is obtained by adding vinylene carbonate (VC) at 2 wt % as an additive to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. For a separator, polypropylene was used.

A lithium metal was prepared as a counter electrode to form coin-type half cells including the above positive electrodes and the like.

### <Discharge Rate Characteristics>

The discharge rate characteristics were measured using the half cells.

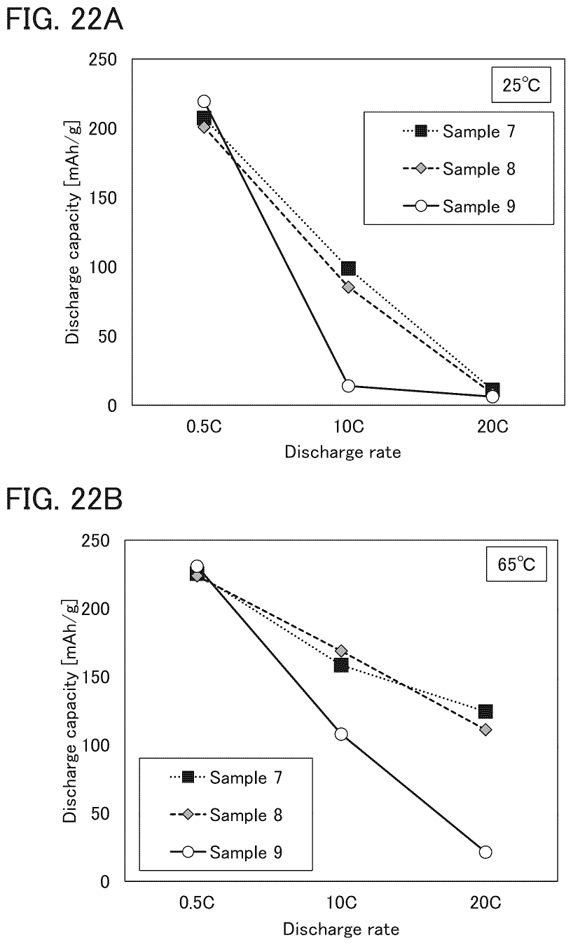

FIG. 22A shows discharge capacity at 0.5 C, 10 C, and 20 C measured at 25° C., and FIG. 22B shows discharge capacity at the above-described rates measured at 65° C. In each case, charging was CC/CV (constant current/constant voltage) (0.5 C, 4.5 V, and 0.05 C cut), and discharging was CC (constant current) (0.5 C, 10 C, or 20 C and 2.5 V cut). Note that 1 C was 200 mA/g.

As shown in FIG. 22A and FIG. 22B, secondary batteries each using the positive electrode active material with a large crystallite size such as Sample 7 or Sample 8 exhibited higher discharge capacity at a high discharge rate exceeding 10 C than the positive electrode active material with a small crystallite size such as Sample 9. For example, the discharge capacity at 25° C. and 10 C was higher than or equal to 70 mAh/g, specifically, 85 mAh/g in Sample 8 and 98 mAh/g in Sample 7. The discharge capacity at 65° C. and 10 C was higher than or equal to 150 mAh/g, specifically, 158 mAh/g in Sample 7 and 168 mAh/g in Sample 8. The discharge capacity at 65° C. and 20 C was higher than or equal to 100 mAh/g, specifically, 111 mAh/g in Sample 8 and 124 mAh/g in Sample 7.

### <Charge Rate Characteristics>

Next, a half cell was fabricated using Sample 21 in a manner similar to the above, and charge rate characteristics were evaluated.

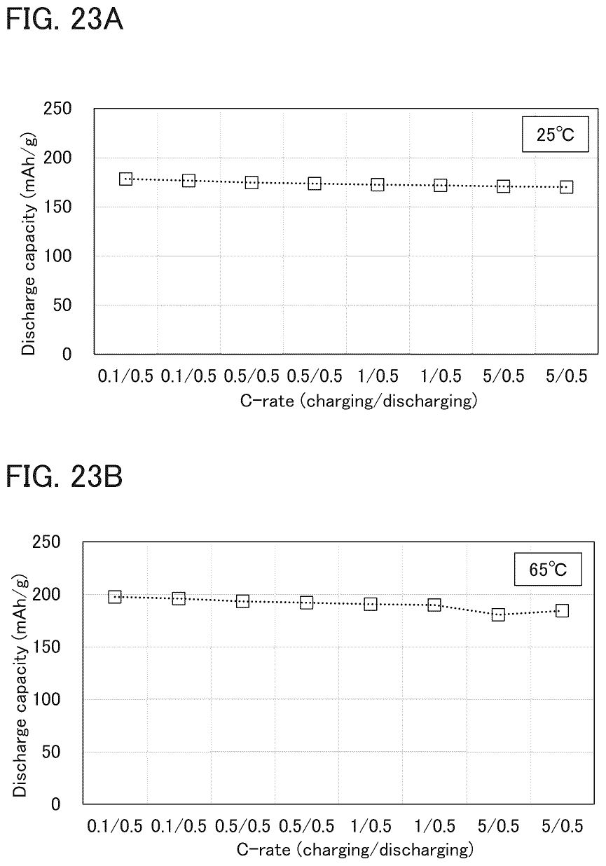

FIG. 23A shows discharge capacity at 0.1 C, 0.5 C, 1 C, and 5 C measured at 25° C., and FIG. 23B shows discharge capacity at the above-described rates measured at 65° C. In each case, charging was CC/CV (0.1 C, 0.5 C, 1 C, or 5 C, 4.5 V, and 0.05 C cut), and discharging was CC (0.5 C and 2.5 V cut). The horizontal axis represents charge and discharge rates as C-rate. Two tests were performed at each of the charge rates of 0.1 C, 0.5 C, 1 C, and 5 C.

As shown in FIG. 23A and FIG. 23B, the discharge capacity was not significantly changed even when the charge rate was changed from 0.1 C to 0.5 C, which revealed that charging and discharging were sufficiently performed even at a high charge rate. For example, the discharge capacity at 25° C. and 5/0.5 (charging/discharging) C was higher than or equal to 150 mAh/g, specifically, 170 mAh/g in both the first time and the second time. The discharge capacity at 65° C. and 5/0.5 was higher than or equal to 170 mAh/g, specifically, at 5/0.5, 180 mAh/g in the first time and 184 mAh/g in the second time.

The above results reveal that the positive electrode active material of one embodiment of the present invention with a large crystallite size has excellent charge and discharge rate characteristics.

### Example 2

In this example, the positive electrode active material 100 in which a primary particle has a large crystallite size and the surface portion 100a contains an additive element was formed.

### <Formation of Positive Electrode Active Material>

Samples formed in this example are described with reference to the formation methods shown in FIG. 6 and FIG. 8.

First, as in Example 1, a composite oxide was formed through Step S11 to Step S56 (Step S57). Next, in Step S71 in FIG. 8, aluminum hydroxide was prepared as a source of aluminum, which is the additive element. In Step S72, the composite oxide and the aluminum source were mixed. The mixing ratio of aluminum was 0.01 (atomic ratio) when the total number of atoms of nickel, cobalt, and manganese was 1.

In Step S73, the mixture of the composite oxide and the aluminum source was heated. The heating was performed in a manner similar to that in Step S43 except that the heating temperature was 800° C. and the heating time was 2 hours. After that, the temperature was cooled down to room temperature, and crushing was performed (Step S74), whereby a positive electrode active material was obtained. This was Sample 32.

Sample 33 was formed in a manner similar to that of Sample 32 except that magnesium was used as the additive element, magnesium carbonate was prepared as a magnesium source, and the mixing ratio of magnesium was 0.01 (atomic ratio) when the total number of atoms of nickel, cobalt, and manganese was 1.

Sample 34 was formed in a manner similar to those of Sample 32 and Sample 33 except that aluminum and magnesium were used as the additive elements and aluminum was 0.005 (atomic ratio) and magnesium was 0.005 (atomic ratio).

Sample 31 was formed in a manner similar to that of Sample 32 except that the additive element was not added.

Table 2 shows the formation conditions of Sample 31 to Sample 34.

TABLE 2

| | Formation conditions | | | | | | |
|---|---|---|---|---|---|---|---|
| | Composite | Li | S43 | S53 | S55 | Additive | S73 |
| | hydroxide | mixing | heating | heating | heating | element | heating |
| Sample 31 | Ni_{0.8}Co_{0.1}Mn_{0.1}(OH)₂ | S42, S52 | 700° C. | 900° C. | 800° C. | — | 800° C. |
| Sample 32 | | | 10 hr | 10 hr | 10 hr | Al | 2 hr |
| Sample 33 | | | | | | Mg | |
| Sample 34 | | | | | | Al, Mg | |

### <Surface SEM>

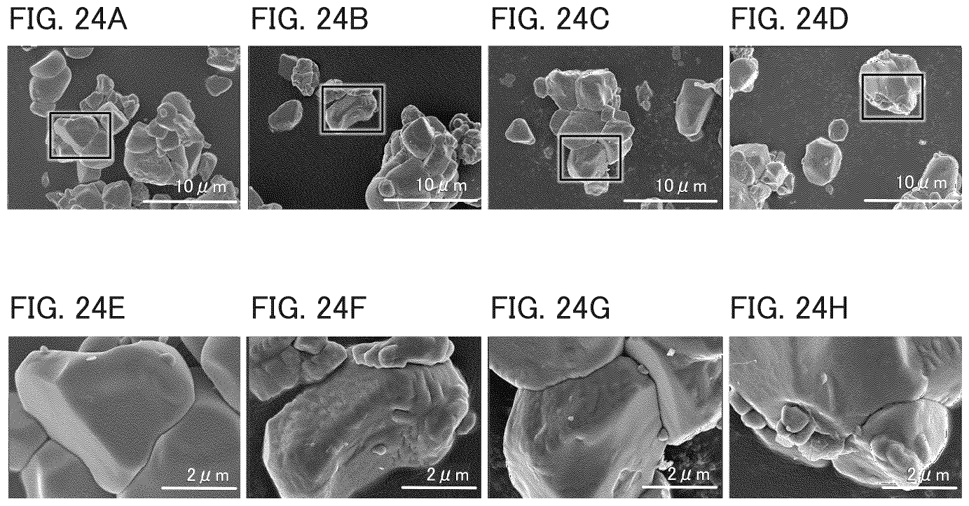

FIG. 24A shows a surface SEM image of Sample 31, FIG. 24B shows a surface SEM image of Sample 32, FIG. 24C shows a surface SEM image of Sample 33, and FIG. 24D shows a surface SEM image of Sample 34. FIG. 24E shows an enlarged image of a square portion in FIG. 24A, FIG. 24F shows an enlarged image of a square portion in FIG. 24B, FIG. 24G shows an enlarged image of a square portion in FIG. 24C, and FIG. 24H shows an enlarged image of a square portion in FIG. 24D.

### <Cross-Sectional SEM-EDX>

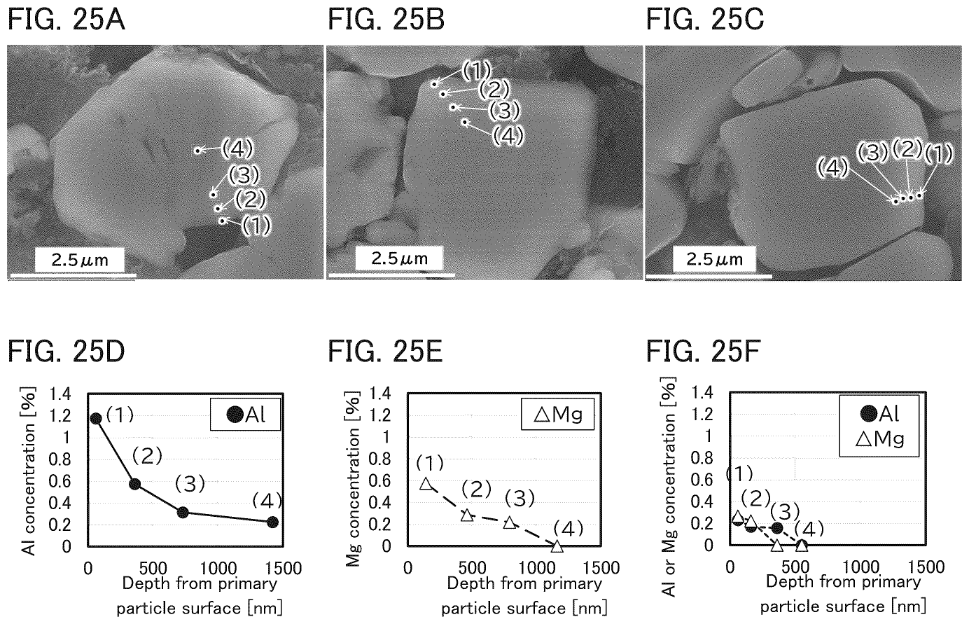

Next, FIG. 25A shows a cross-sectional SEM image of Sample 32, FIG. 25B shows a cross-sectional SEM image of Sample 33, and FIG. 25C shows a cross-sectional SEM image of Sample 34. EDX point analysis was performed on portions denoted by (1) to (4) in FIG. 25A, and the measured aluminum concentrations are shown in FIG. 25D. In a similar manner, FIG. 25E shows the magnesium concentrations at portions denoted by (1) to (4) in FIG. 25B. FIG. 25F shows the aluminum concentrations and the magnesium concentrations at portions denoted by (1) to (4) in FIG. 25C. In each sample, the aluminum concentration and the magnesium concentration decreased from the surface portion 100a toward the inner portion.

As shown in FIG. 24A to FIG. 25F, Sample 32 to Sample 34 were each found to be a positive electrode active material with a large crystallite size in which the additive element concentration is higher in the surface portion 100a than in the inner portion.

### REFERENCE NUMERALS

100: positive electrode active material, 100a: surface portion, 100b: surface portion, 100c: inner portion, 101: crystal grain boundary, 104: coating film

1. A positive electrode active material comprising:
a plurality of transition metal elements;
oxygen; and
at least one of a first additive element and a second additive element,
wherein the plurality of transition metal elements comprise nickel, manganese, and cobalt,
wherein each of the first additive element and the second additive element comprises one of magnesium, aluminum, calcium, titanium, and zirconium,
wherein the positive electrode active material comprises a first surface portion, a second surface portion, and an inner portion,
wherein the second surface portion is closer to the inner portion than the first surface portion is,
wherein a ratio of nickel to the total number of atoms of the plurality of transition metal elements is higher in the inner portion than in the first surface portion and the second surface portion,
wherein a ratio of the number of atoms of at least one element selected from cobalt and manganese to the total number of atoms of the plurality of transition metal elements is higher in the second surface portion than in the inner portion, and
wherein a concentration of at least one of the first additive element and the second additive element is higher in the first surface portion than in the inner portion and the second surface portion.

2. The positive electrode active material according to claim 1,
wherein a crystallite size of the positive electrode active material calculated using an XRD pattern is greater than or equal to 150 nm.

3. A secondary battery comprising:
a positive electrode comprising a positive electrode active material and a negative electrode,
wherein the positive electrode active material comprises:
a plurality of transition metal elements;
oxygen; and
at least one of a first additive element and a second additive element,
wherein the plurality of transition metal elements comprise nickel, manganese, and cobalt,
wherein each of the first additive element and the second additive element comprises one of magnesium, aluminum, calcium, titanium, and zirconium,
wherein the positive electrode active material comprises a first surface portion, a second surface portion, and an inner portion,
wherein the second surface portion is closer to the inner portion than the first surface portion is,
wherein a ratio of nickel to the total number of atoms of the plurality of transition metal elements is higher in the inner portion than in the first surface portion and the second surface portion,
wherein a ratio of the number of atoms of at least one element selected from cobalt and manganese to the total number of atoms of the plurality of transition metal elements is higher in the second surface portion than in the inner portion, and
wherein a concentration of at least one of the first additive element and the second additive element is higher in the first surface portion than in the inner portion and the second surface portion.

4. The secondary battery according to claim 3,
wherein a crystallite size of the positive electrode active material calculated using an XRD pattern is greater than or equal to 150 nm.

5. A positive electrode active material comprising:
a plurality of transition metal elements and oxygen,
wherein the plurality of transition metal elements comprise nickel, manganese, and cobalt,
wherein a crystallite size of the positive electrode active material calculated using an XRD pattern is greater than or equal to 150 nm, and
wherein after CC/CV charging at 25° C. with an upper limit voltage of 4.5 V, a constant current of 100 mA/g, and a termination current of 10 mA/g, a secondary battery using the positive electrode active material has a discharge capacity of higher than or equal to 70 mAh/g in CC at 2000 mA/g.

6. A secondary battery comprising a positive electrode comprising:
a positive electrode active material according to claim 5; and
a negative electrode.
